(19) United States
(12) Patent Application Publication
(10) Pub. No.: US 2007/0212267 A1
(43) Pub. Date: Sep. 13, 2007

(54) Method and apparatus for performing micro-scale chemical reactions

(75) Inventors: Michael Organ, Burlington (CA); Eamon Comer, Brookline, MA (US)

Correspondence Address: NIXON & VANDERHYE, PC, 901 NORTH GLEBE ROAD, 11TH FLOOR, ARLINGTON, VA, 22203, US

(73) Assignee: Total Synthesis Ltd., Burlington (CA)

(21) Appl. No.: 11/711,831

(22) Filed: Feb. 28, 2007

Related U.S. Application Data
(63) Continuation of application No. PCT/CA05/01333, filed on Aug. 31, 2005.
(60) Provisional application No. 60/605,505, filed on Aug. 31, 2004.

(51) Int. Cl. B01J 19/00

(52) U.S. Cl. 422/130

(57) ABSTRACT

A reactor apparatus includes at least one reaction capillary having a lumen for receiving a reactant to undergo a reaction, and a magnetron for irradiating reactant contained in at least a portion of the capillary with microwaves. A method of micro-reacting a reactant includes providing a capillary, and irradiating the reactant in the capillary with microwaves to facilitate a chemical reaction in the capillary by which the reactant is converted into a desired product.

This application is a continuation of International Application No. PCT/CA2005/001333, filed Aug. 31, 2005, which is an application claiming the benefit of U.S. Provisional Application No. 60/605,505, filed Aug. 31, 2004, each of which are incorporated herein by reference.

### FIELD

This invention relates to micro reactor technology (MRT), and to a method and apparatus for performing chemical reactions.

### BACKGROUND

The number of publications in microwave assisted organic synthesis has increased dramatically in recent years. This growth in popularity can be attributed to reduction in reaction times compared to conventional heating methods. Microwave heating has also been reported to increase yields and produce cleaner reactions than traditional heating. A method of performing organic reactions in a continuous flow manner with microwave heating has been developed recently for relatively large (gram scale) organic synthesis

The performance of organic reactions on very small scale in microchannels has many advantages such as the ability to perform high throughput synthesis with a minimum amount of starting materials. Minimizing the required amount of starting materials can be advantageous since the materials can be valuable or, in some cases, hazardous. Microreactor technology can provide benefits for drug discovery by allowing for high throughput screening of a large number of compounds that are quickly available using this method. Additionally, higher yields are reported for some reactions in microreactors compared to larger batch scale synthesis. Traditionally, reactions on microscale quantities have been performed at room temperature in microreactors, however, it would be of considerable advantage if these reactions could be carried out at higher temperatures using microwave heating.

Microwave heating has recently been disclosed in association with micro-reactors using etched micro-chips. This method generally includes that a metal strip be attached on the outside of the chip to absorb microwave energy, which in turn can transfer the energy (generally as heat) to the reaction. This method can be very costly, since etching of micro-channels in a microchip, as well as attaching the metal strip, can be time-consuming and the metal itself (generally of gold) can be expensive.

### SUMMARY

The following summary is intended to introduce the reader to this specification but not to define any invention. In general, this specification discusses one or more methods or apparatuses for performing reactions at micro-scale levels that can advantageously use minimal starting components and generate minimal waste. According to some embodiments, the present specification provides reaction capillaries in which a reactant can undergo a reaction to provide a desired product. In accordance with the present specification, reactions performed in capillaries with microwave irradiation can provide a dramatic rate enhancement, illustrating that these small-volume reaction vessels in capillary form are quite able to pick up the ‘microwave effect’, and can yet avoid some of the drawbacks associated with known microreactors and methods of their use.

The apparatus of the present specification can advantageously use readily available inexpensive/disposable capillary tubes that require no special fabrication. The capillary tubes can be of various sizes with different diameters, which can be selected for respective desired effects on microwave absorption and on factors such as laminar flow. The tubes can be generally straight to reduce or eliminate the risk of blockage. The capillary tubes can have an inner film or lining to allow for a more efficient heating of a reactant in contact with the film or lining. The capillary tubes can include a treatment media supported in the lumens for contacting the reactant and/or product passing through the capillaries. The treatment can be in the form of polymeric balls or granules, coated or infused with one or more treatment compounds. The treatment compounds can include secondary reagents, catalysts, and/or scavengers.

The method of the present specification can facilitate the production of libraries of compounds in a continuous flow manner, i.e. allows for the high throughput continuous production of libraries of compounds. The method can also facilitate the formation of relatively large quantities of products that can be isolated for analysis using standard analytical procedures. Increased quantity of a desired product can be produced by operating the apparatus of the present specification for a longer period of time (i.e. running continuous flow for longer), and keeping the volume of the components as they interact in the reaction generally constant.

The present invention can be particularly well suited for green chemistry in which water is present and which absorbs microwave radiation readily.

In accordance with a first aspect, the present specification provides a reactor apparatus having at least one reaction capillary having a lumen for receiving a reactant to undergo a reaction, and a magnetron for irradiating reactant contained in at least a portion of the capillary with microwaves.

The reactor apparatus can have an inner surface that is provided with a lining adapted to facilitate the reaction of the reactant. The lining can be of a microwave-absorbing material, and/or can be of a material that provides a chemical catalyst for the reaction. The lining can be of palladium, and can have a thickness of about 6 microns.

The reactor apparatus can include a reactant supply in fluid communication with the lumen of the capillary, and can include a manifold coupled downstream of the reactant supply and upstream of the capillary. The manifold can have at least one outlet port and a plurality of inlet ports in fluid communication with the at least one outlet port. The reactant supply can include a plurality of reagent reservoirs in fluid communication with respective ones of the plurality of inlet ports of the manifold. The reactor apparatus can include a flow inducer for urging the reagent from each reservoir to the respective inlet ports.

The reactor apparatus can be provided with a collection vessel at a downstream end of the reaction capillary for receiving product from the capillary. An analyzer can be provided in fluid communication with the downstream end of the capillary for in-process confirmation of satisfactory reaction of the reactant within the capillary. The reaction capillary can have an axial length extending between upstream and downstream ends, and about 1 cm thereof can be exposed directly to the microwaves. The reaction capillary can have an inner diameter that is less than about 1500 microns.

In accordance with a second aspect, the present specification provides a capillary tube device for providing a reaction chamber, the device having a generally cylindrical wall having an inner surface defining a lumen, and a reaction enhancing film lining the inner surface, the film configured to contact a reactant contained in the device.

The film can be of a material consisting of or including metal, and can be of palladium. The film can have a thickness of between about 2 to about 10 microns, and can be about 6 microns. The lumen can have axially opposed upstream and downstream ends for receiving liquid into and dispensing liquid from the device, respectively, the lumen being generally straight between the upstream and downstream ends.

According to another aspect, the present specification provides a method of micro-reacting a reactant, the method including providing a capillary; passing a reactant through the capillary; and, irradiating the reactant in the capillary with microwaves to facilitate a chemical reaction in the capillary by which the reactant is converted into a product.

The capillary can include a reaction-enhancing film on an inner surface thereof for contacting the reactant passing through the capillary. The microwave energy can be absorbed by the film and transferred to the reactant as heat. The film can provide a chemical catalyst for the reaction, can be of palladium, and can be about 6 microns in thickness.

According to yet another aspect, the present specification provides a method of forming a thin film on a surface, the method including preparing a carrier solution containing a desired film material in generally dissolved form; filling a tube with the carrier solution; heating the tube and carrier solution contained therein until the dissolved material has deposited on an inner surface of the tube; and evacuating the solution from the tube.

The method can include heating the emptied tube with the deposited film material thereon. The carrier solution can include palladium acetate, and can include an amount of base solution. The base solution can include potassium hydroxide. During heating of the filled tube, the tube can be periodically re-oriented to promote uniform deposition of the film material on the inner surface of the tube.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a reactor apparatus in accordance with an example of the present specification;

FIG. 2 is a schematic view of the apparatus of FIG. 1;

FIG. 3 is an enlarged view in cross-section of a capillary element of the apparatus of FIG. 1;

FIG. 4 is a perspective view of a reactor apparatus in accordance with another example of the present specification;

FIG. 5 is a schematic view of the reactor apparatus of FIG. 4;

FIG. 6 is a modified manifold element of the apparatus of FIG. 4;

FIG. 7a is a photograph of a lining element in accordance with the present specification, taken at 50× magnification;

FIG. 7b is a photograph of an edge portion of the lining of FIG. 7a, taken at 5000× magnification;

FIGS. 7c to 7e are photographs of a front surface portion of the lining of FIG. 7a, taken at 1500×, 30000×, and 100000× magnification, respectively; and

FIG. 8 is a schematic view of another alternate example of a reactor apparatus in accordance with the present specification.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

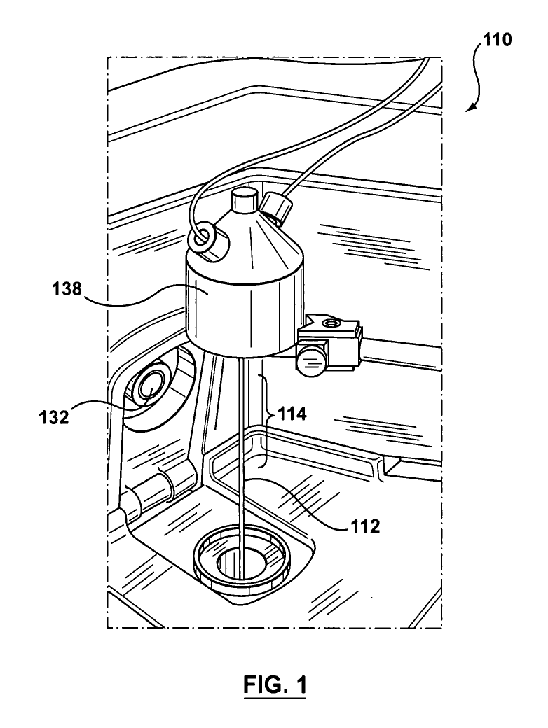

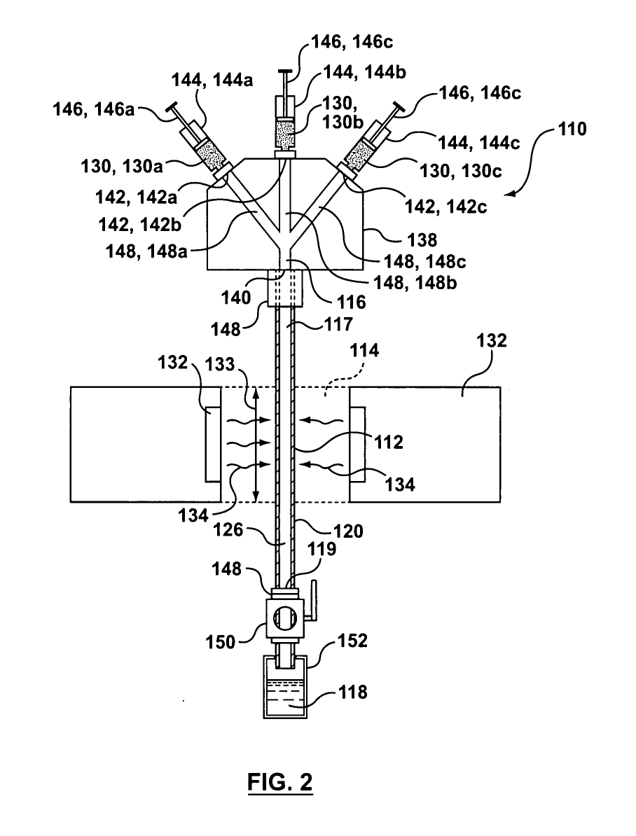

A reactor apparatus 110 in accordance with one example of the present specification is generally shown in FIGS. 1 and 2. The reactor apparatus 110 includes at least one reaction capillary 112 and a treatment chamber 114 through which at least a portion of the capillary 112 extends.

The capillary 112 can be generally characterized as a fine diameter tube configured to receive a reactant 116. The reactant 116 is generally defined by a selected substance or mixture that is desired to undergo a chemical reaction to produce a product 118. The capillary 112 has an upstream or inlet end 117 for receiving the reactant 116, and a downstream or outlet end 119 for discharging the product 118.

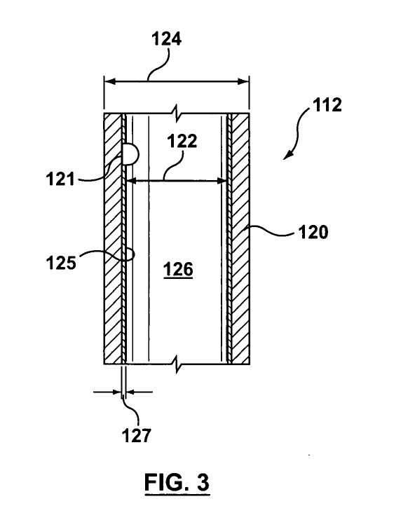

With reference also to FIG. 3, in the example illustrated, the capillary 112 has a generally cylindrical wall 120 having an inner surface 121, an inner diameter 122 and an outer diameter 124. The wall 120 is, in the example illustrated, of a glass (or boron silicate) material, although other materials can also be used. The wall 120 can be provided with a thin film 125 (also referred to herein as a lining) on its inner surface that can facilitate the reaction in which the reactant 116 produces the product 118. Further details of the film 125 are provided subsequently herein.

The capillary 112 has a generally hollow interior defining a lumen 126 through which the reactant 116 and product 118 can flow. The inner diameter 122 of the capillary 112 is generally small in relation to its length. For example, the inner diameter 122 can be generally less than about 1.5 mm or less than about 2.0 mm. In particular embodiments, capillaries 112 having inner diameters 122 of about 200 microns, of about 380 microns, and of about 1200 microns have been found to perform satisfactorily.

The reactant 116 can include one or more starting materials or input reagents 130. In the example illustrated, the reactant 116 includes a mixture of three input reagents 130 identified as 130a, 130b, and 130c. One or more of the reagents 130 can include a solvent or catalyst. The product 118 can similarly include one or more output components, and can include an amount of unreacted reactant 116.

The treatment chamber 114 is generally adapted to facilitate the initiation and/or progress of the reaction by which the product 118 is produced from the reactant 116. The treatment chamber 114 can be adapted to impart energy to the reactant 116 in the reaction capillary 112 to facilitate the reaction. In the example illustrated, the apparatus 110 includes a magnetron 132 configured to direct microwave energy (identified at arrows 134 in FIG. 1) towards the capillary 112 in the treatment chamber 114. The magnetron 132 extends, in the illustrated embodiment, along about 1 cm of the axial length of the capillary 112, defining a treatment chamber length 133. The volume of the lumen 126 of the capillary 112 that is generally located in the treatment chamber 114 defines a reaction chamber. The reaction chamber generally contains a mixture of reactant 116 and product 118, while upstream and downstream of the reaction chamber, mostly only reactant 116 and product 118, respectively, will exist.

To facilitate introduction of the reactant 116 into the inlet end 117 of the capillary 112, the apparatus 110 can be provided with a manifold 138. The manifold 138 has an outlet port 140 that provides a supply of the reactant 116 for the capillary 112. The manifold 138 can have a plurality of inlet ports 142. In the example illustrated, the manifold 138 has three inlet ports 142, identified as 142a, 142b, and 142c for receiving a separate supply of the reagents 130a, 130b, and 130c, respectively. The reagents 130a, 130b, and 130c can be delivered in respective vials 144a, 144b, and 144c that can be coupled to the respective inlet ports 142a, 142b, 142c.

The vials 144 can be in the form of, for example, but not limited to, syringes or commercially pre-filled containers or flasks. The vials 144 can each be coupled to respective flow inducers 146 for urging a respective reagent 130 from the vial 144 to the respective inlet port 142. The flow inducers 146 can be in the form of, for example, but not limited to, peristaltic pumps or syringe pumps (shown schematically in FIG. 1).

Each of the inlet ports 142 of the manifold 138 is in fluid communication with the outlet port 140 via respective feed channels 148 (i.e. channels 148a, 148b, and 148c, respectively) extending through the body of the manifold. The manifold 138 can be constructed of a non-reactive material with respect to the reagents 130 and/or reactant 116, and in the example illustrated is of stainless steel construction.

To use the apparatus 110, the reaction components or reagents 130 necessary to perform the desired chemical transformation can be selected and loaded separately into the vials 144. This may require separating the reagents 130 from each other, and can include separation of any components and/or catalysts necessary to make the transformation from reactant 116 to product 118. The particular selection of the various reagents 130 can generally be determined by the nature of the reaction components themselves, the reaction being performed, and/or the application for the reaction. The separate reagents 130 can include a homogeneous or heterogeneous solution; both are generally suitable for use with the apparatus 110.

The vials 144 can then be coupled to the respective inlet ports 142 of the manifold 138, and the flow inducers 146 (e.g. syringe pumps) can be adjusted to provide a desired supply/flowrate.

In some embodiments, the vials 144 can be coupled to the inlet ports 130 using a snap-fit coupler. Alternatively, the vials 144 can be coupled to the inlet ports 130 by other means, such as, for example, tubing. In some cases the manifold 138 may have more inlet ports 130 than the number of vials 144 being used for a reaction, in which case the unused inlet ports 130 can be capped off.

If the capillary 112 is not already in place, the inlet end 117 thereof can be coupled to the outlet port 140 of the manifold 138. A suitable connector for coupling the capillary to the manifold can be, for example, a Microtight™ connector, shown generally at 148.

The outlet end 119 of the capillary 112 can be coupled to a collection and/or analysis device as desired. A switching valve 150 can be placed in the effluent stream leaving the capillary to toggle the effluent between, for example, a collection device, an analytical device, and waste. Alternatively, the effluent stream can be split between analysis and collection with an additional setting to direct it to waste. In the example illustrated, the outlet end 119 of the capillary 112 is coupled to a collection vessel 152 that can be in the form of, for example, but not limited to, a test tube, flask, or fraction collector.

If not already so, the capillary 112 can be positioned in the treatment chamber 114. The capillary 112 can be arranged laterally so that the capillary 112 is aligned with a central portion of the magnetron 132.

To initiate the reaction, the syringe pumps 146 can be set into operation at the desired flowrates, and the magnetron 132 can be powered at a desired power setting to deliver the desired amount of energy to the reactant 116 in the capillary 112. As the reactant 116 flows through the capillary 112 in the treatment chamber 114, the reactant 116 is irradiated by the microwaves 134. The flow rates of the pumps 146 and the power settings for the magnetron 132 can be adjusted to heat the reactant 116 an amount that provides optimum yield of the product 118 from the reactant 116.

Once the reaction has started, the first (transient condition) amount of product 118 can be directed to waste via valve 150. Once all non-irradiated material (or otherwise corrupt, pre-steady state material) has exited the capillary 112, the product 118 can be collected in a collection vessel and/or analysed.

The apparatus 110 can thus facilitate production of the product 118 from the reactant 116 in a controlled manner and with high yield. The apparatus 110 can also provide a reaction channel (i.e. the lumen 126) that is generally straight (non-undulating) between the inlet end 117 and outlet end 119 of the capillary 112, so that the risk of blockage of the lumen 126 due to, for example, solidification of the reactant 116 and/or product 118 passing through the lumen 126 is greatly reduced. In the example illustrated, the capillary 112 is oriented generally vertically, with the inlet end 117 positioned vertically above the outlet end 119. The apparatus 110 can be used to provide increased quantities of a desired product 118 by flowing more reactant 116 through the capillary 112, and keeping the size of the reaction chamber constant. Effects of “scaling up” the volumes of the reagents in contact with each other during the reaction are thus avoided.

Variations to the apparatus 110 and its method of use as described above can be made within the scope of the present specification. For example, the reactant 116 can be prepared by mixing reagents 130 in a beaker, for example, withdrawing a desired amount of the reactant 116 in a syringe or vial, and coupling the vial to the inlet end 117 of the capillary 112, so that the manifold 138 is not required. Such pre-mixed reactant 116 can be of heterogeneous or homogenous composition. As another variation, the capillary 112 can be configured in a U-shape, rather than a straight vertical configuration. A U-shaped configuration can increase the exposure of the reactant 116 to the microwaves 134 without increasing the size of the magnetron 132. In another variation, the outlet end 119 of the capillary can be coupled to the inlet of a second apparatus 110 positioned downstream of the first apparatus 110. The second apparatus 110 can use as a reagent 130 the product 118 of the first apparatus. The present specification includes aspects of these or any other variations of embodiments described herein combined separately or in combination with aspects of one or more other embodiments described herein.

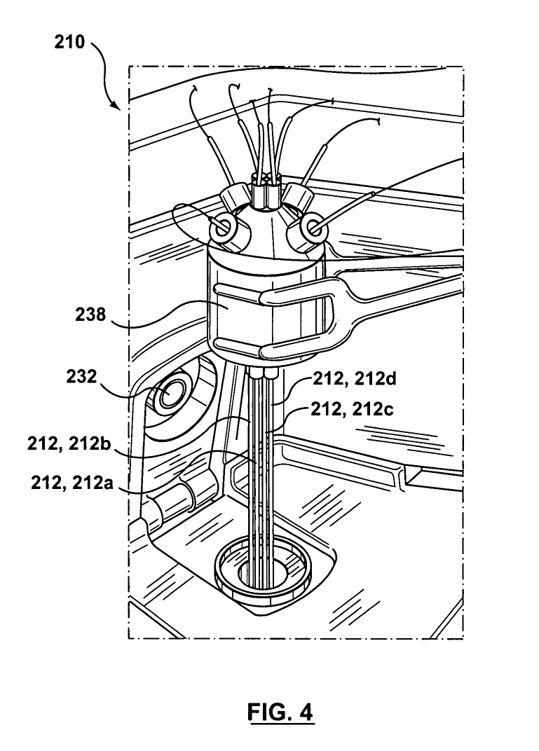

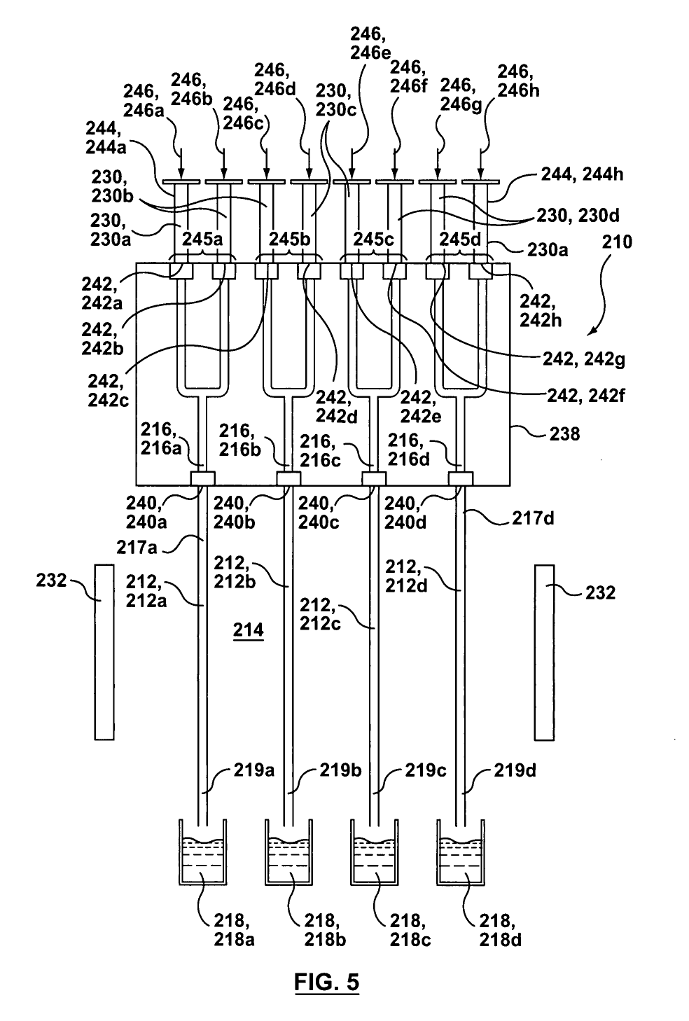

Another example of a reactor apparatus 210 in accordance with the present specification is shown in FIGS. 4 and 5. The reactor 210 has many similarities to the reactor 110, and like features are identified by like reference characters, incremented by 100.

The reactor 210 has a plurality of parallel reaction capillaries 212 extending through a treatment chamber 214. Each of the plurality of capillaries 212 can receive distinct reactants 216, respectively, so that the reactor 210 can facilitate preparing libraries of distinct products 218 simultaneously by parallel capillary microwave irradiation.

The reactor 210 can include a manifold 238 having a plurality of outlet ports 240, each one of which can be coupled to a respective one of the plurality of reaction capillaries 212. The manifold 238 can have a plurality of inlet ports 242.

In the example illustrated, the manifold 238 has eight inlet ports 242, identified as inlet ports 242a-242h. The manifold 238 has four outlet ports 240, identified as outlet ports 240a, 240b, 240c, and 240d. The apparatus 210 has four parallel reaction capillaries 212, identified as 212a, 212b, 212c, and 212d. Each capillary 212 has a respective inlet end 217 coupled to a respective one of the outlet ports 240.

As best seen in FIG. 5, in the example illustrated, the inlet ports 244 are arranged in four inlet port pairs 245a, 245b, 245c, and 245d. Each inlet port 244 in one pair 245 is in fluid communication with a common one of the four outlet ports 240. For example, the inlet port pair 245a include inlet ports 242a and 242b, each of which are in fluid communication with the outlet port 240a. The inlet port pair 245d include inlet ports 242g and 242h, each of which are in fluid communication with the outlet port 240d. In this way, two distinct reagents 130 can be combined to form a respective one of the reactants 116 being supplied to a respective reaction capillary 212.

Eight distinct reagents 130 can be coupled to respective ones of the inlet ports 242a-242h. Alternatively, one or more inlet ports 242 in different pairs of ports can share a common reagent 230. In the example illustrated, four reagents 230a, 230b, 230c, and 230d are provided. Each pair 245 of inlet ports 242 is supplied with a distinct combination of two of the four reagents 230a, 230b, 230c, and 230d. In particular, for the illustrated embodiment, inlet ports 242a and 242b are supplied with reagents 230a and 230b, respectively, which combine to form reactant 216a at outlet port 240a. Inlet ports 242c and 242d are supplied with reagents 230b and 230c, respectively, which combine to form reactant 216b at outlet port 240b. Inlet ports 242e and 242f are supplied with reagents 230c and 230d, respectively, which combine to form reactant 216c at outlet port 240c. Inlet ports 242g and 242h are supplied with reagents 230d and 230a, respectively, which combine to form reactant 216b at outlet port 240b.

This method can be used to produce compounds (products 218) in successive multiples of four. This can facilitate the simultaneous generation of libraries of distinct products 218 that have some reagents in common. Simultaneous generation of the products 218 can ensure that each distinct product 218 has been produced under similar operating conditions, which can facilitate subsequent comparative use of the products 218. Preparing multiple products (four in the example illustrated, but many more capillaries could also be provided) can also greatly reduce the amount of time required to prepare a desired collection of products.

In use of the reactor apparatus 210, separated reagents 230 are supplied to the inlet ports 242 of the manifold 238. Each reagent 230 is combined with one or more other reagents 230 to provide distinct reactants 216. The reactants 216 are delivered to the parallel reaction capillaries 212 where they react while being irradiated.

The method of using the reactor apparatus 210 is similar to the method of using the apparatus 110. The method includes selecting the reaction components (i.e. reagents 230) necessary to provide the four products 218a-218d, including the appropriate solvent, reactants, catalysts, etc., and loading them separately, as necessary, into separate vials 244. In the example illustrated, the two reagents 230 that react to form the desired product 218 for each reaction capillary 212 will be in separate, but paired vials 244.

The flow inducers 246 can be adjusted to provide the desired supply/flowrate of the reagents 230. The reaction capillaries 212 can be connected to the outlet ports 240 of the manifold 238 using the appropriate connectors.

The outlet end 219 of the reaction capillaries 212 can be connected to a collection or analysis device as required. A switching valve can be placed in the effluent streams from each capillary 212 to toggle the effluent between a collection device, an analytical device, and waste. Alternatively, the effluent stream can be split between analysis and collection with an additional setting to direct it to waste.

The flow inducers 246 can be activated and the magnetron 232 can be energized at the desired power settings to deliver the desired/optimized microwave energy to the reactants 216 in the reaction capillaries 212.

Based on the volume of the capillaries and flowrate, collection and/or analysis of the products (effluent) from the bottom of the capillary 212 can begin, once all non-irradiated material is known to have cleared the capillary entirely.

Once a sufficient quantity of the desired products 218 has been collected, the vials 244 can be replaced with by a second group of vials containing the reagents for making a second batch of four products.

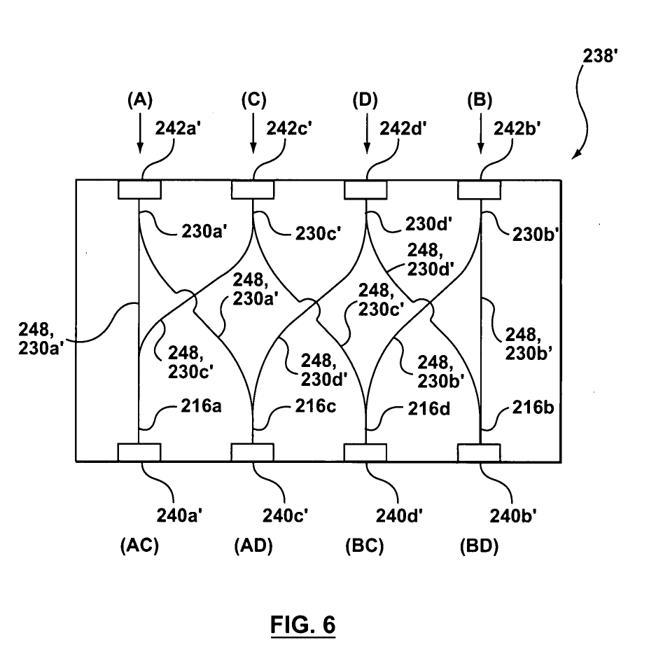

The apparatus 210 and method of its use can be varied within the scope of the present specification. For example, as seen in FIG. 6, a modified manifold 238′ can be used in place of the manifold 238. In the modified manifold 238′, each inlet port 242′ can be in fluid communication with more than one outlet port 240′, and each outlet port 240′ can be in fluid communication with more than one inlet port 242′. In the example illustrated, the modified manifold 238′ has four active inlet ports 242′ (rather then eight), identified as inlet ports 242a′, 242b′, 242c′, and 242d′. Each of the four inlet ports 242′ can be in fluid communication with two of the outlet ports 240′. For example, the inlet port 242a′ can be in fluid communication with the outlet ports 240a′ and 240c′. The inlet port 242b′ can be in fluid communication with outlet ports 240b′ and 240d′. The inlet port 242c′ can be in fluid communication with outlet ports 240a′ and 240d′; and, the inlet port 242d′ can be in fluid communication with outlet ports 240b′ and 240c′.

In such an alternative embodiment, each of the inlet ports 242a′-242d′ is adapted to be coupled to a respective reagent reservoir or vial 244a′-244d′, each containing a respective reagent 230a′-230d′. Each capillary 212a-212d thus receives a respective reactant 216a-216d and produces a respective product 218a-218d. For example, the capillary 212a receives reactant 216a (from outlet port 240a′) and dispenses product 218a. The reactant 216a includes reagents 230a and 230c. The capillary 212d receives reactant 216d (from outlet port 240d′) and dispenses product 218d. The reactant 216d includes reagents 230b and 230c.

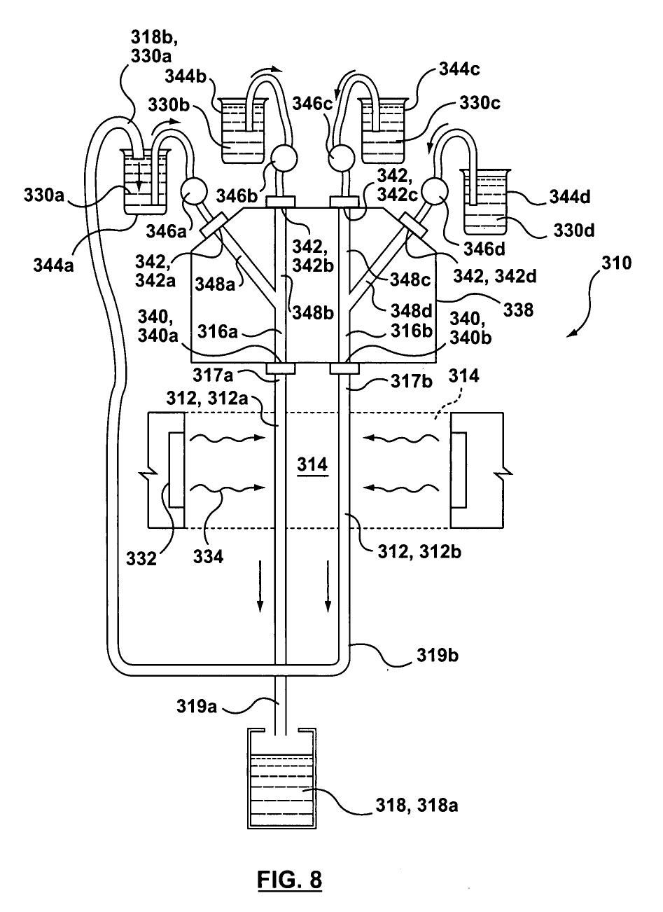

Another example of a reactor apparatus 310 can be seen in FIG. 8. The apparatus 310 is similar to apparatus 210, and like features are identified by like reference characters, incremented by 100. In apparatus 310, the outlet ends 319 of one or some of the reaction capillaries 312 can be coupled to one or some of the inlet ports 342 of the manifold 338. In this way, a product 318 from a capillary 312 can serve as a reaction intermediate that can be fed back into the manifold 338 as a reagent 330. Such a configuration can provide automated multi-step microwave-assisted synthesis functionality.

Further details of the film or lining 125 will now be described. The lining 125 can be provided on any one or more of the capillaries 112, 212, described above. As well, although described herein in relation to the capillaries 112, 212, the present specification comprehends that the lining 125 and methods of making such a lining 125 can be used in applications other than for capillaries 112, 212.

The lining 125 is generally in the form of thin layer or coating of material provided on the inner surface of the capillaries. The lining 125 can be of a material such as, for example, but not limited to, a metal or metal-containing material that readily absorbs energy from the microwaves 134, and can store and transfer this energy (generally in the form of heat) to the reactant 116 in contact with the lining 125. The lining 125 can also be of a material that serves as a chemical catalyst for the reaction taking place within the reaction capillary 112, 212. Suitable materials for the lining 125 can include, but not limited to, palladium, silver, copper, nickel, gold, rhodium, and/or platinum.

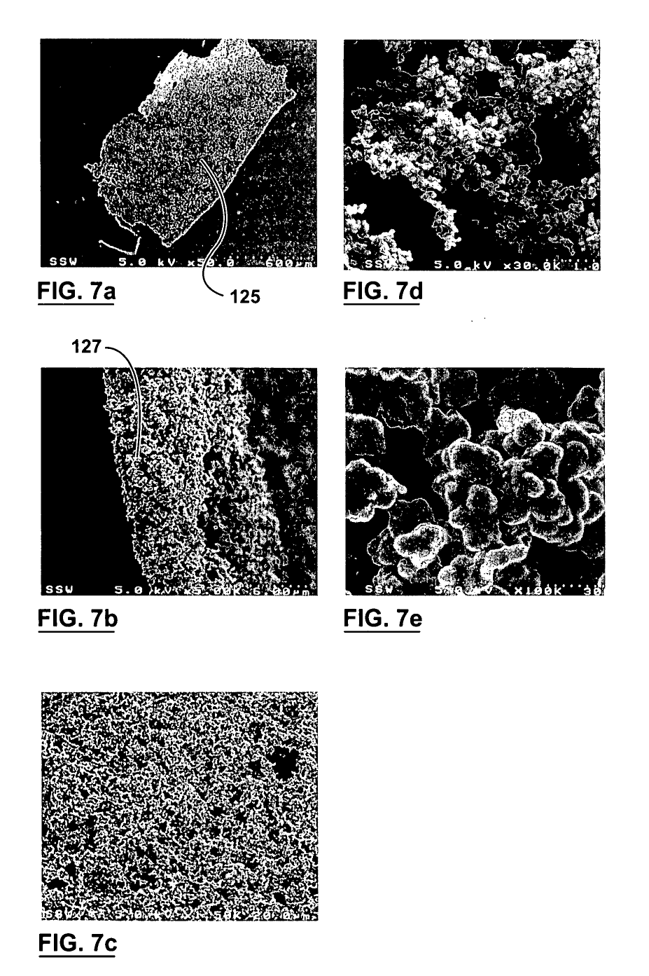

Referring now also to FIGS. 7a-7e, in one embodiment, the lining 125 is of elemental palladium. The lining 125 can have a thickness 127 of about 2 microns to about 10 microns, or generally less than about 15 microns. Such a lining 125 has been found to satisfactorily act as a catalyst in many reactions, and to absorb energy from the microwaves 134 and transfer this as heat to the reactant 116 in the capillary 112. The lining thickness 127 should be kept sufficiently thin to prevent arcing of the microwaves 134, and to prevent melting of the lining 125.

The lining 125 can have a relatively high porosity (about 75%), and the porosity can be generally uniform (FIG. 7c). The film or lining 125 can include small grains that are of a size of about 40 to 60 mm in diameter (FIGS. 7d and 7e). For the sample shown in FIG. 7a, the thickness 127 of the film 125 is about 6 microns (edge shown in FIG. 7b).

EDX analysis was performed on the film formed in the capillary as well as on films that were prepared on glass plates. The linings 125, after the solution has been drained, but prior to calcinations, contained an average of 28 wt % of carbon while for the calcinated sample this was lower, having a value of about 15 wt %. For the capillary 112 this amount was lower down to 5.5 wt %. This can be explained by the increase in porosity that allows trapped carbonaceous material to be removed more efficiently. The films prepared in the capillary included a majority of Pd (about 94.0 wt %) and only about 0.3 wt % of oxygen was detected. This can be a result of the presence of a thin oxide film on the Pd. No other elements were detected. The presence of such a small amount of carbon and oxygen indicates that the film is mostly metallic.

Using the capillary weight change before and after the film preparation, film thickness, and the dimension of the capillary, it was possible to evaluate the density of the Pd film to be about 3 mg/cm³. This would correspond to a porosity of about 75%.

In summary, the films 125 prepared according to the method of the present specification (described further hereinafter) can be highly porous and composed of nanometer size grains (94.0 wt % Pd and 5.5 wt % carbon). The film thickness can be about 6 microns and the film porosity can be of the order of 75%.

In accordance with the present specification, the following method is provided for producing the lining 125. A 0.1 mmol/mL stock solution of palladium acetate in DMF or DMA is prepared. An amount of the stock solution can be mixed with a base solution, to provide a carrier solution. For example, 1.0 mL of the stock solution can be mixed with 0.2 mL of a base solution in the form of an aqueous solution of potassium hydroxide (2M) in a vial, forming a carrier solution. The base (potassium hydroxide) is optional and can increase the rate of metal deposition.

The internal surface of the capillary 112 is cleaned using a 10% aqueous solution of hydrofluoric acid. An amount of 1.0 mL of the intermediate solution is taken up in a 1.0 mL syringe. In place of a needle extending from the syringe, a capillary is coupled to the neck of the syringe by, for example, wrapping tape around the end of the capillary to ensure they are coupled together in leak-proof fashion.

The carrier solution is then introduced into the capillary so that the lumen 126 is generally filled along at least a portion of its axial length. The inlet and outlet ends 117 and 119 can be plugged using tape or septa.

The filled capillaries 112 can then be placed on a metallic tray and put inside of a laboratory thermal furnace. In accordance with one example of the present specification, the temperature of the furnace can be raised gradually and then kept constant at about 120° C. to 160° C. for about 30 to 120 minutes.

The palladium, which can begin to release almost immediately from the carrier solution, starts to deposit gradually on the inner surface 121 of the capillary 112. The capillaries 112 can be rolled several times to facilitate uniform coating.

After the coated capillaries are removed from the furnace, the residual solution inside the capillaries can be evacuated. The temperature of the furnace is then raised to 350° C.-400° C. The capillaries are placed back inside the furnace and calcinated up to 1 minute. This calcination step can be repeated, and in the example illustrated, was repeated twice (total of three calcination treatments). This can help to ensure increased porosity, the removal of residual organic material, and a firmer adhesion of the metal film 125 to the glass surface 121.

The coated capillaries 112 can then be transferred to a clean airtight test tube under argon atmosphere for safe storage until required for use.

Variations of the above method can be made within the scope of the specification. For example, the palladium coating 125 of the capillaries 112 can also be carried out using a carrier solution that has not been mixed with a base solution, or that is generally the same as the stock solution. Without a base, it can take longer for palladium to be released from the carrier solution.

The effect of the “baking” of the film morphology was explored. It is apparent that heating the sample lining 125 to about 350° C. to 400° C. for about 3 minutes causes the porosity of the film 125 to increase. This seems to indicate that residual carbonaceous material is mostly located on top of the Pd grains (“baking” temperature is well below Pd annealing temperature). We have noted however that the film morphology is more compact when the films are prepared on flat glass plates. This is thought to result from the different film geometrical configurations, namely, that a smaller amount of solution is used in the preparation of the capillary lining 125 (capillary 112 filled with fixed amount of solution) while the plate is immersed in a larger amount of solution.

The film preparation for morphology and composition analysis was identical to the one used in the microwave synthesis. The capillary was cleaved and pieces of the films were fixed on a carbon tape for analysis. Films were also prepared on 1 cm² flat glass substrates bit dipping the glass in the preparation solution. Sample imaging was carried out with an Hitachi S-4500 field emission Scanning Electron Microscopy (SEM) equipped with EDAX Phoenix model energy dispersive x-ray (EDX) analyzer. EDX analysis can detect all elements above atomic number 5 and has a minimum detection limit of 0.5 wt % for most elements. A 5 kV electron beam was used to obtain SEM images and EDX spectra. Both the lower and upper SE detectors were used for imaging purposes.

The film morphology was analyzed using Scanning Electron Microscopy (SEM) and Energy Dispersive x-ray (EDX) analyzer. The images presented here were obtained from a piece of the film that was removed from the capillary wall (see FIG. 7a). FIGS. 7a to 7e show the film morphology for increasing magnification (see figure caption).

The reactor apparatus 110, 210, 310 of the present specification can be applied to the concept of flowing a solution containing starting materials through a vessel that is loaded with secondary reagents, catalysts, and/or scavengers to facilitate organic synthesis offers. This can have huge potential for industries based on synthetic chemistry. Increasingly, such approaches are starting to show up in the chemical literature, although the flow concept, in one form or another, in larger scale industrial synthesis is not new. In such a scheme, secondary reagents, catalysts and/or scavengers are immobilized in the vessel on either a solid support or on the sides of the vessel itself.

According to the present specification, the loaded vessel can be a tube of some sort, and can be a capillary 112 having a treatment compound supported within the lumen 126, for contacting the reactant 116 and/or product flowing through the lumen 126. Axially spaced-apart ends of the capillary 112 can be fritted such that the treatment is contained within the capillary 112, but solutions containing dissolved starting materials (i.e. components of the reactant 116) can readily flow through, reacting as they do. The movement of the starting material solutions (also referred to herein as primary reagents) through the vessel can either be uninterrupted, continuous flow, or it can be by stop flow. In a continuous flow situation, the reactions involved should be fast enough to complete before the starting materials traverse the axial extent of the capillary. For slower conversion, a plug of starting materials (or primary reagents) can be moved into the vessel or capillary 112, held there for a period of time to allow the reaction to complete and then be discharged from the vessel.

The development of smaller scale, flow-through synthetic systems can have a major impact on areas such as the pharmaceutical and agrochemical industries, where the idea is generally not to produce large quantities of any one compound, but rather to produce larger numbers of single compounds to screen for desirable activity. The advantages of small-scale flow synthesis using immobilized reagents, catalysts, or scavengers in this type of application are many.

For example, any unused secondary reagent, and ideally any reagent byproducts, the catalyst, and/or the scavenger, remain attached to the support after they have reacted and generally do not contaminate the product effluent leading to compounds that are, ideally, pure enough to screen without additional purification. The savings in terms of time, consumables, and waste production from the large-scale purification of hundreds or thousands of compounds can result in huge savings to industry and may reduce any negative impact on the environment from such activities.

Vessels filled with the appropriate supported compounds can be produced on large scale very cheaply and can therefore be viewed as a consumable and disposable commodity to the industrial or academic scientist. There would be enormous savings potential in terms of cost in setting reactions up by chemists who instead can buy the vessel ready to be used.

The potential exists to set up consecutive vessels to facilitate in-line synthesis and purification (where necessary) and to be able to perform reactions in sequence so that several transformations can be conducted in one overall operation. Here the product effluent from one reaction vessel can flow, as necessary, through a purification vessel loaded with scavengers, and then into the next reaction vessel to conduct another chemical transformation. This can be repeated as often as necessary until all transformations have been completed.

### Description of Reagent-filled Capillary Devices Designed Specifically For Applications to Microreactor Microwave Application

According to the present specification, the capillaries 112 can include one or more treatment compounds retained in the lumen 126. The treatment compounds can be immobilized inside of the capillary, either on a solid support that resides in the lumen of the capillary or on the wall of the capillary itself. The treatment compounds can include one or more of a secondary reagent, a catalyst, or a scavenger. The terms secondary reagent, catalyst, and scavenger are described below.

A secondary reagent is defined as a chemical entity that reacts with a starting reactant (or primary reagent) during a synthetic procedure and is consumed in the process to produce a desired product. Atoms from the secondary reagent may, or may not be incorporated into the product of that reaction, but the secondary reagent is consumed in the procedure. If used in excess relative to the molar quantity of the starting reactant, and it is not otherwise consumed in the transformation, residual reagent will be in the reaction mixture upon completion.

A catalyst is a chemical entity, which can be organic or inorganic in nature, that is helpful and/or necessary to effect a chemical transformation where a starting component, and possibly additional reagents, are converted to a desired product. The catalyst is generally not consumed or destroyed and, although parts of the catalyst may be incorporated in the process, it is returned intact or regenerated after each turnover of starting reactant to product.

A scavenger is a chemical entity that is added to a chemical reaction, typically when the reaction is judged complete, to purify the product from residual reactants and/or reagents, catalysts, or other possible reaction byproducts so that the product is obtained in relatively pure form. The scavenger is typically attached to some sort of a solid medium, or to the wall of the vessel, such that the product can be obtained by simple filtration. In some cases, multiple scavengers are required that can either be added to the crude reaction mixture together, or one after another separated by filtration steps to remove the preceding scavenger and its associated scavenged material from the transformation. The pharmaceutical industry generally considers a product that is greater than 80% pure to be suitable for early stage biological screening. As methods and scavengers improve, this industrial standard will increase and some companies will now only screen material that is greater than 90% pure. Although analytically pure products are always desirable for such screening, it is recognized that the time and waste involved in large-scale chromatographic purification of every single product in a large collection, called a chemical or molecular library, is prohibitive from a cost and environmental point of view.

### Nature of the Immobilization

The treatment compounds can be immobilized in a number of fashions. Immobilizations to the capillary wall itself can be done by laying down a coating on the glass surface that these chemical entities can bond, adhere or coordinate to, or to bond these chemical entities directly to the glass itself. One such example would be the metal films 125 described previously, where the metal film adheres to the surface of the glass and can serve as a chemical catalyst to convert starting reactants to desired products.

In another embodiment, the treatment compounds can be attached, either by an ionic, coordinate and covalent bond, to a matrix that fills the capillary that is sufficiently porous to allow adequate flow as not to create undesirable back pressure on the system. Here, the treatment compound can be attached to the smaller building blocks that form the matrix, or they can be attached to the matrix after it is formed inside the capillary. The matrix is either held in the capillary by its association with the glass wall of the capillary, or by a frit, or by both. One such example of a matrix would be sol-gel derived porous glass (silica).

In another embodiment, the treatment compound can be attached to a treatment media retained in the lumen of the capillary and of sufficient size that it can be held within the capillary by a frit or by a sufficient narrowing of the end of the capillary. The treatment media can be a solid entity, such as, for example, but not limited to, organic polymeric beads (both swelling and non-swelling), porous and non-porous glass beads, silica gel of any mesh size, inorganic supports such as clays, or organic supports such as graphite. In these cases, the treatment compound(s) can be loaded/bonded onto the solid supported material outside of the capillary and then loaded into it. Alternatively, the treatment media can be first loaded into the capillary, and then a solution containing the treatment media can be flowed into the capillary where they become loaded onto the media.

### Description of a Typical Operation/Setup Using a Filled Capillary

Capillaries that have been supplied with the appropriate treatment compound can be installed in the apparatus 110, 210, 310. Operation of the device with the filled capillaries generally follows similar protocols as outlined above in the DETAILED DESCRIPTION OF THE INVENTION section in terms of capillary attachment to device 138 and 238, the attachment of reactant (130) vials, and flow of the solution containing the reactant and/or additional reagents, as necessary as determined by the chemistry that needs to be conducted, through the capillary while it is being irradiated with microwave irradiation.

### Reagent Filled Capillaries

In one scenario, the starting component (or primary reagent) 130 can be loaded into a vial (144) with a suitable solvent and is infused through a capillary loaded with a supported secondary reagent necessary to complete the desired chemical transformation. The supported secondary reagent can contain atoms that become incorporated into the product. In this case, there is generally no need to include additional reagents in the same solution with the starting component 130, or in a separate vial that merges with the starting component 130 when it enters the manifold 138.

There may, or may not be the need to include a catalyst in with the reactant 116 in order to effect its transformation with the supported secondary reagent. If there are additional inlet ports in the manifold that merge with this the reaction flowing through the reagent-filled capillary is irradiated in the microwave chamber (312) and the effluent can be directly collected in a collection device (118). Further, the effluent can be sent to an analytical device to measure conversion to product, or the effluent stream can be split to flow both to a collection device and to an analytical station.

In a second scenario, the reaction is set up as detailed above, but additional reagents or catalysts are necessary to complete the reaction that are best kept separate until they are mixed in the manifold (138), immediately prior to entering the reagent-filled capillary. The flow process is started and the conjoined flows flow through the capillary while being irradiated by microwave irradiation. The product effluent is then processed as detailed above.

### Catalyst Filled Capillaries

In this case, the starting components 130 that are necessary for the chemical transformation are loaded into one or more vials attached to the manifold (138) and flowed through a solid-supported or capillary wall-supported catalyst. The flow process is started and the conjoined flows flow through the capillary while being irradiated by microwave irradiation. The product effluent is then processed as detailed above.

### Scavenger Filled Capillaries

Scavenger-filled capillaries are used primarily to purify a product mixture. Such a mixture could be formed by a flow method, or a batch prepared method where the material was produced in a single flask without flow. Microwave heating pushes the scavenging process more quickly to completion and leads to cleaner product mixtures. So, a scavenger-filled capillary can be attached to a manifold, such as 138, or not, and the product mixture is flowed through this capillary while being irradiated with microwave irradiation and the product handled as described above.

### Sequential Filled Capillary Operations

As mentioned previously in this patent application, operations can be set up in a queued fashion, one after another, to perform multiple-step organic transformations. The same can be applied to the filled capillaries. This can be the case for sequential secondary reagent-filled capillaries, catalyst-filled capillaries, and any combination of the two. Also, in-line chromatography can be carried out as well by linking these reagent or catalyst-filled capillaries to a scavenger-filled capillary, thus completing one or more chemical transformation steps and chromatography.

### Parallel Sequential-Filled Capillary Operations

All of the above mentioned procedures involving the single reaction capillary reactor system can also be conducted in parallel to produce multiple products simultaneously.

While the above description provides examples of one or more processes or apparatuses, it will be appreciated that other processes or apparatuses may be within the scope of the accompanying claims.

### EXAMPLES

Some representative examples of the classes of reactions performed using methods in accordance with the present specification are described below.

The following standard abbreviations are used throughout the Examples:
DMF N,N-Dimethylformamide
DMSO Dimethylsulfoxide
THF Tetrahydrofuran
RBF Round Bottom Flask
RT or rt Room temperature
TBAF Tetrabutylammonium flouride
Fmoc 9-fluorenylmethoxycarbonyl
equiv. equivalent(s)
cat. catalyst
h hour(s)

All conversions were determined by ¹H NMR and represent the quantity of product relative to starting material. Thus, in reactions where the conversion is reported as 80% the remainder of the material is starting material. All reactions were preformed in a continuous flow mode. The method of operation involved first priming the system with the solvent of choice, then the reaction mixture was continuously flowed through the system with the aid of a syringe pump while heating at a constant power level with a constant microwave irradiation.

### Example 1: Suzuki Reaction Using One Inlet Stream

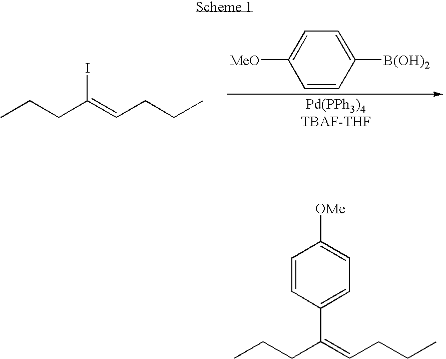

| | | Capillary | | | | |
|---|---|---|---|---|---|---|
| Entry | Power | Diameter | Flowrate | | Solvent | Conversion |
| 1 | 100 W | 200 μm | 2 | μl/min. | THF | 100% |
| 2 | 160 W | 200 μm | 5-40 | μl/min | THF | 65% |

| | | | | | |
|---|---|---|---|---|---|
| 3 | RT | RBF | Batch rxn | THF | 0% |
| | | | control | | |

Scheme 1 conditions: 1 equiv. of vinylhalide, 1.1 equiv. boronic acid, 5 equiv. of base, 5 mol % Pd(PPh₃)₄ in THF.
Batch rxn control refers to the identical reaction performed under similar conditions (i.e. same concentration) using “standard” chemical techniques (i.e. round bottomed flask with stirrer) at room temperature.

### Example 2

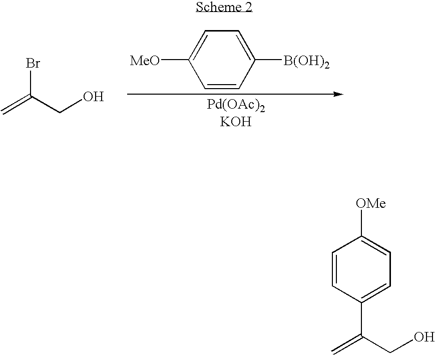

| | | Capillary | | | |
|---|---|---|---|---|---|
| Entry | Power | Diameter | flowrate | Solvent/base | Conversion |
| 1 | 170 W | 380 μm | 40 μl/min | DMF/H₂O | 43% |
| 2 | 150 W | 380 μm | 40 μl/min | DMF/H₂O | 39% |
| 3 | RT | RBF | Batch rxn | DMF/H₂O | 0% |
| | | | control. | | |

Scheme 2 conditions: 1 equiv. of vinylhalide, 1.2 equiv. boronic acid, 3 equiv. of base, 5 mol % Pd(OAc)₂ in DMF/H₂O.

### Example 3

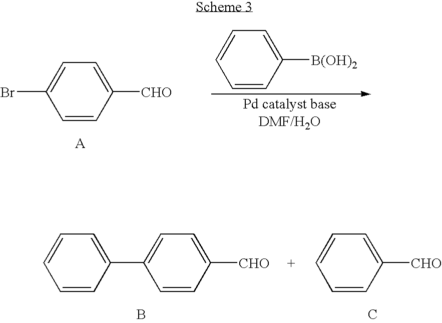

| Entry | Power | Capillary Diameter | Flowrate | Base/Catalyst | Ratio A:B:C |
|---|---|---|---|---|---|
| 1 | 160 W | 200 μm | 40 μl/min | K₂CO₃ | 93(A):7(B) |
| | | | | Pd(OAc)₂ | |
| *2 | 90° C. 2 h, | RBF | Control | K₂CO₃ | 100 (B) |
| | 60° C. | | | Pd(OAc)₂ | |
| | 14 h. | | | | |
| **3 | 170 W | 200 μm | 40 μl/min | KOH | 37(A):48(B):15(C) |
| | | | | Pd(OAc)₂ | |
| **4 | 170 W | 380 μm | 40 μl/min | KOH | 11(A):54(B):35(C) |
| | | | | Pd(OAc)₂ | |
| 5 | 170 W | 380 μm | 40 μl/min | K₂CO₃ | 26(A):74(B) |
| | | | | Pd(PPh₃)₄ | |

Scheme 3 conditions: 1 equiv. of arylhalide, 1.2 equiv. boronic acid, 3 equiv. of base, 5 mol % Pd catalyst in DMF/H₂O.
Ratio A:B:C represents the ratio of the 2 products B and C relative to starting material A as determined by ¹H NMR. In entries were A and C are not specified, they were not observed.
*Entry 2 refers to the identical reaction performed under similar conditions (i.e. same concentration) as in entry 1, using “standard” chemical techniques (i.e. round bottomed flask with stirrer) at 90° C. for 2 h then at 60° C. for 14 h with the aid of an oil bath.
**These reactions were performed with a capillary tube which was coated internally with palladium (i.e. capillary 112 with lining 125).

### Example 4

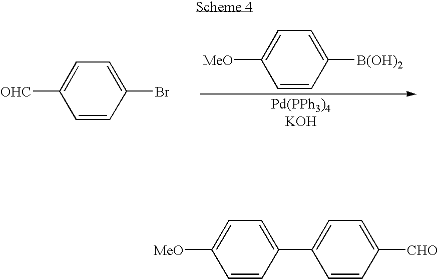

| | | Capillary | | | |
|---|---|---|---|---|---|
| Entry | Power | Diameter | Flowrate | Solvent | Conversion |
| 1 | 170 W | 380 μm | 40 μl/min | DMF/H₂O | *91% |
| 2 | RT | RBF | Batch rxn | DMF/H₂O | 32% |
| | | | control | | |

Scheme 4 conditions: 1 equiv. of arylhalide, 1.2 equiv. boronic acid, 3 equiv. of base, 5 mol % Pd(PPh₃)₄ in DMF/H₂O.

### Example 5

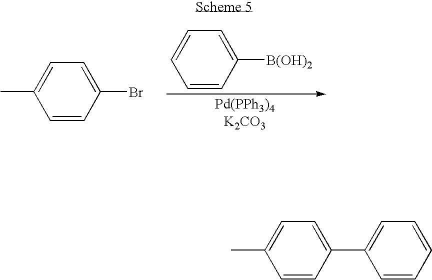

| | | Capillary | | | |
|---|---|---|---|---|---|
| Entry | Power | Diameter | Flowrate | Solvent | Conversion |
| 1 | 170 W | 380 μm | 40 μl/min | DMF/H₂O | *55% |
| 2 | RT | RBF | Batch rxn | DMF/H₂O | 34% |
| | | | control | | |

*compound isolated by chromatography
Scheme 5 conditions: 1 equiv. of arylhalide, 1.2 equiv. boronic acid, 3 equiv. of base, 5 mol % Pd(PPh₃)₄ catalyst in DMF/H₂O.

### Example 6

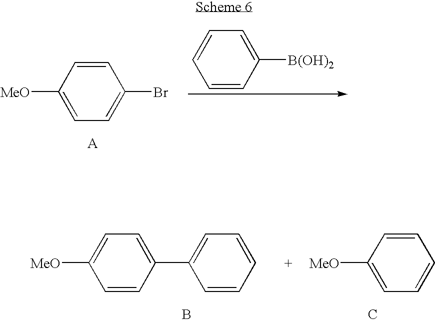

| | | | | Solvent/ | |
|---|---|---|---|---|---|
| | | Capillary | | Catalyst/ | |
| Entry | Power | Diameter | Flowrate | Base | Ratio A:B:C |
| *1 | 170 W | 380 μm | 25 μl/min | DMF/H₂O, | 30(A):17(B):53(C) |
| | | | | Pd(OAc)₂, KOH | |
| **2 | RT | RBF | Control | DMF/H₂O, | 0% |
| | | | | Pd(OAc)₂, KOH | |
| 3 | 170 W | 380 μm | 25 μl/min | THF, Pd(PPh₃)₄, | 28(A):17(B) |
| | | | | TBAF | 55(C) |
| ***4 | RT | RBF | Control | THF, Pd(PPh₃)₄, | 0% |
| | | | | TBAF | |
| 5 | 80° C. | RBF | Control | THF, Pd(PPh₃)₄, | 12 min, 100(A):0(B) |
| | | | | TBAF | 22 min, 100(A):0(B) |
| | | | | | 1.5 h, 100(A):0(B) |
| | | | | | 18 h, 0(A):100(B) |

Scheme 6 conditions: 1 equiv. of arylhalide, 1.2 equiv. boronic acid, 3 equiv. of base 5 mol % Pd catalyst.
Ratio A:B:C represents the ratio of the 2 products B and C relative to starting material A as determined by ¹H NMR. In entries were C is not specified, it was not observed.
*This reaction was performed with a capillary tube which was coated internally with palladium.
**Entry 2 refers to the identical reaction as entry 1, performed under similar conditions (i.e. same concentration) using “standard” chemical techniques (i.e. round bottomed flask with stirrer) at room temperature.
***Entry 4 refers to the identical reaction as entry 3, performed under similar conditions (i.e. same concentration) using “standard” chemical techniques (i.e. round bottomed flask with stirrer) at room temperature.

### Example 7

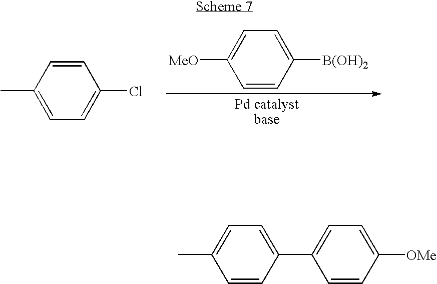

| | | Capillary | | Solvent/ | |
|---|---|---|---|---|---|
| Entry | Power | Diameter | Flowrate | catalyst | Conversion |
| 1 | 170 W | 380 μm | 25 μl/min | DMF/H₂O | 0% |
| | | | | Pd(PPh₃)₄ | |
| 2 | 170 W | 380 μm | 25 μl/min | DMF/H₂O | 0% |
| | | | | Pd(PPh₃)₄ | |
| **3 | 170 W | 380 μm | 25 μl/min | DMF/H₂O | *37% |
| | | | | Pd(OAc)₂ | |
| **4 | 200 W | 380 μm | 15 μl/min | DMF/H₂O | 26% |
| | | | | Pd(OAc)₂ | |
| **5 | 170 W | 380 μm | 15 μl/min | DMF/H₂O | 28% |
| | | | | Pd(OAc)₂ | |

Scheme 7 conditions: 1 equiv. of arylhalide, 1.2 equiv. boronic acid, 3 equiv. of base, 5 mol % Pd catalyst in DMF/H₂O.
*compound isolated by chromatography
**These reactions were performed with a capillary tube which was coated internally with palladium.

### Example 8

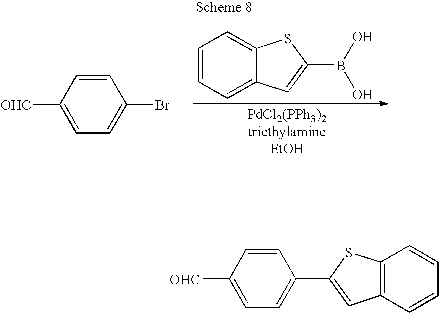

| | | Capillary | | | |
|---|---|---|---|---|---|
| Entry | Power | Diameter | Flowrate | Solvent | Conversion |
| 1 | 170 W | 380 μm | 25 μl/min | EtOH | 25% |

Scheme 8 conditions: 1 equiv. of arylhalide, 1 equiv. boronic acid, 3 equiv. of triethylamine 5 mol % Pd catalyst in EtOH.

### Example 9

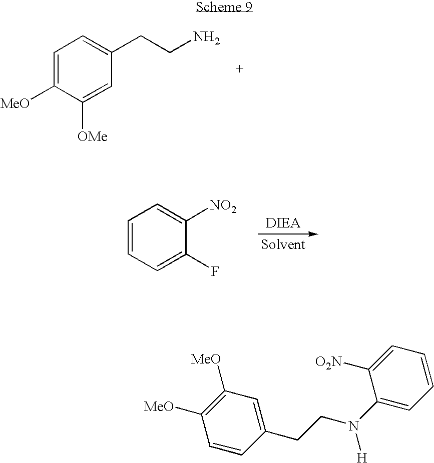

| | | Capillary | | | | | |
|---|---|---|---|---|---|---|---|
| Entry | Power | Diameter | | flowrate | | solvent | Conversion |
| 1 | 150 W | 380 | μm | 25 | μl/min | EtOH | 68% |
| 2 | RT | RBF | | Batch | | EtOH | 0% |
| | | | | Control | | | |
| 3 | 200 W | 380 | μm | 10 | μl/min | EtOH | 83% |
| 4 | 170 W | 380 | μm | 25 | μl/min | DMF | 100% |
| 5 | RT | RBF | | Batch | | DMF | 68% |
| | | | | Control | | | |
| 6 | 100 W | *380 | μm | 25 | μl/min | EtOH | 68% |
| 7 | 150 W | 380 | μm | 25 | μl/min | **EtOH | 56% |
| 8 | 150 W | 380 | μm | 25 | μl/min | EtOH | 55% |
| 9 | 200 W | 380 | μm | 2-5 | μl/min | EtOH | 40% |
| 10 | 170 W | 1100-1200 | μm | 10 | μl/min | EtOH | 75% |
| 11 | 200 W | 1100-1200 | μm | 5 | μl/min | EtOH | 77% |

Scheme 9 conditions: 1 mmol of fluoronitrobenzene, 2 mmol of diisopropylethylamine and 2 mmol of 3,4-Dimethoxyphenylethylamine.
*This reaction was performed with a capillary tube which was coated internally with palladium.
**same conditions as entry 1 with the exception that the concentration of starting reagents diluted by a factor of 2.
Entry 2 refers to the identical reaction as entry 1, performed under similar conditions (i.e. same concentration) using “standard” chemical techniques (i.e. round bottomed flask with stirrer) at room temperature.
Entry 5 refers to the identical reaction as entry 4, performed under similar conditions (i.e. same concentration) using “standard” chemical techniques (i.e. round bottomed flask with stirrer) at room temperature.

### Example 10

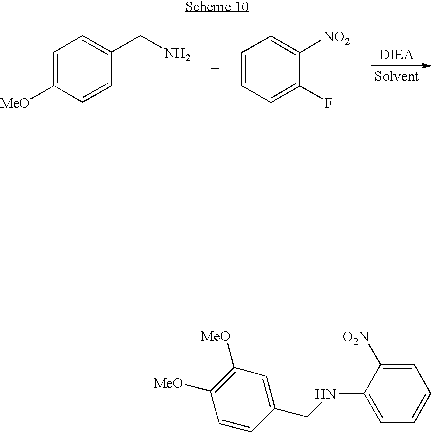

| | | Capillary | | | |
|---|---|---|---|---|---|
| Entry | Power | Diameter | Flowrate | Solvent | Conversion |
| 1 | 170 W | 380 μm | 25 μl/min | EtOH | 84% con |
| 2 | RT | RBF | Batch control | EtOH | 13% con |
| 3 | 170 W | 380 μm | 25 μl/min | DMF | 92% con |
| 4 | RT | RBF | Batch control | DMF | 31% con |

Scheme 10 conditions: 1 mmol of fluoronitrobenzene, 2 mmol of diisopropylethylamine and 2 mmol of 4-methoxybenzylamine.
Entry 2 refers to the identical reaction as entry 1, performed under similar conditions (i.e. same concentration) using “standard” chemical techniques (i.e. round bottomed flask with stirrer) at room temperature.
Entry 4 refers to the identical reaction as entry 3, performed under similar conditions (i.e. same concentration) using “standard” chemical techniques (i.e. round bottomed flask with stirrer) at room temperature.

### Example 11

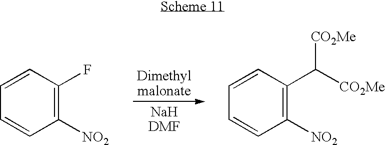

| | | Capillary | | | |
|---|---|---|---|---|---|
| Entry | Power | Diameter | Flowrate | Solvent | Conversion |
| 1 | 100 W | 380 μm | 40 μl/min | DMF | 72% |
| 2 | RT | RBF | Batch Control | DMF | 28% |
| | | | RT | | |

Scheme 11 conditions: 1 equiv. of arylhalide, 2.5 equiv. of dimethyl methylmalonate, 2.5 equiv. of sodium hydride, in DMF.
Entry 2, batch control rxn, refers to the identical reaction as entry 1, performed under similar conditions (i.e. same concentration) using “standard” chemical techniques (i.e. round bottomed flask with stirrer) at room temperature.

### Example 12

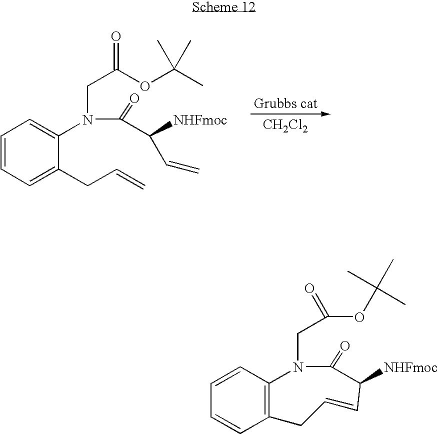

| | | Capillary | | | |
|---|---|---|---|---|---|
| Entry | Power | Diameter | Flowrate | Solvent | Conversion |
| 1 | 100 W | 380 μm | 40 μl/min | CH₂Cl₂ | 100% |

Scheme 12 conditions: 1 equiv. of diene, 1 mol % Grubbs catalyst in CH₂Cl₂.

### Example 13

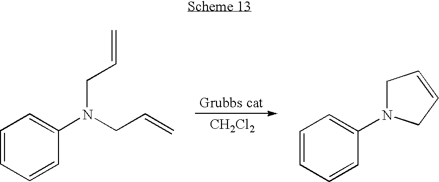

| | | Capillary | | | |
|---|---|---|---|---|---|
| Entry | Power | Diameter | Flowrate | Solvent | Conversion |
| 1 | 150 W | 380 μm | 30 μl min | CH₂Cl₂ | 45% |

Scheme 13 conditions: 1 equiv. of diene, 1 mol % Grubbs catalyst in CH₂Cl₂.

### Example 14

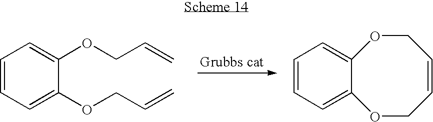

| | | Capillary | | | |
|---|---|---|---|---|---|
| Entry | Power | Diameter | Flowrate | Solvent | Conversion |
| 1 | 150 W | 380 μm | 30 μl/min | CH₂Cl₂ | 28% |
| *2 | 50 W | 380 μm | 30 μl/min | CH₂Cl₂ | 14% |
| *3 | 50 W | 380 μm | 40 μl/min | Toluene | 35% |
| *4 | 20 W | 380 μm | 40 μl/min | Toluene | 13% |
| 5 | RT | RBF | Batch rxn | CH₂Cl₂ | 32% |
| | | | Reflux 16 h | | |
| 6 | RT | RBF | Batch control | CH₂Cl₂ | 10% |

Scheme 14 conditions: 1 equiv. of diene, 1 mol % Grubbs catalyst in CH₂Cl_{2 or toluene.}
*These reactions were performed with a capillary tube which was coated internally with palladium.
Entry 5 refers to the identical reaction as entry 1, performed under similar conditions (i.e. same concentration) using “standard” chemical techniques (i.e. round bottomed flask with stirrer) performed at reflux with the aid of an oil bath.
Entry 6 refers to the identical reaction as entry 1, performed under similar conditions (i.e. same concentration) using “standard” chemical techniques (i.e. round bottomed flask with stirrer) at room temperature.
Green Chemistry; Reactions in the section used only water as solvent.

### Example 15

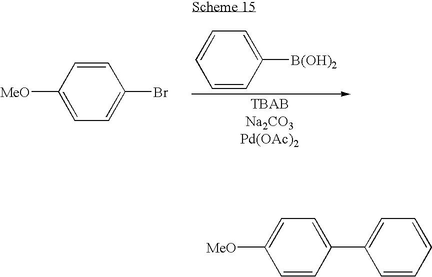

| | | Capillary | | | |
|---|---|---|---|---|---|
| Entry | Power | Diameter | Flowrate | Solvent | Conversion |
| 1 | 100 W | 380 μm | 25 μl/min | H₂O | 62% |
| 2 | 170 W | 380 μm | 25 μl/min | H₂O | 100% |
| 3 | RT | RBF | Batch | H₂O | 38% after 1 h |
| | | | Control RT | | |

Scheme 15 conditions: 1 equiv. of arylhalide, 1 equiv. boronic acid, 1 equiv. tetrabutylammonium bromide, 3 equiv. of base, 5 mol % Pd catalyst in H₂O.
Entry 3, batch control reaction refers to the identical reaction as entry 1, performed under similar conditions (i.e. same concentration) using “standard” chemical techniques (i.e. round bottomed flask with stirrer) performed at room temperature for 1 h.

### Example 16

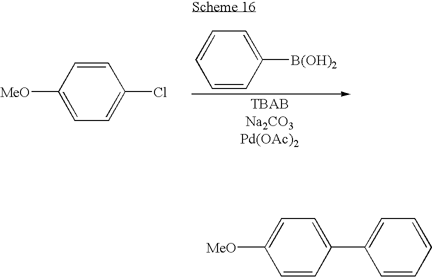

| | | Capillary | | | |
|---|---|---|---|---|---|
| Entry | Power | Diameter | Flowrate | Solvent | Conversion |
| 1 | 170 W | 380 μm | 25 μl/min | H₂O | 100% |

Scheme 16 conditions: 1 equiv. of arylhalide, 1 equiv. boronic acid, 1 equiv. tetrabutylammonium bromide, 3 equiv of base, 5 mol % Pd catalyst in H₂O.
Using Two Inlet Streams: reactions in this section used 2 inlet streams each containing a reagent

### Example 17

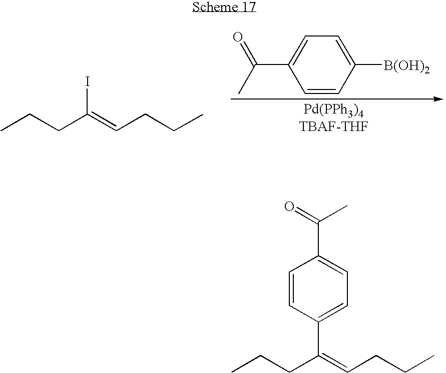

| | | Capillary | | | |
|---|---|---|---|---|---|
| Entry | Power | Diameter | flowrate | Solvent | Conversion |
| 1 | 100 W | 380 μm | 15 μl/min. | THF | 100% |

Scheme 17 conditions: Stream A; 1 equiv. of vinylhalide, 5 equiv. of base, 5 mol % Pd(PPh₃)₄ catalyst in THF. Stream B; 1 equiv. boronic acid in THF.

### Example 18

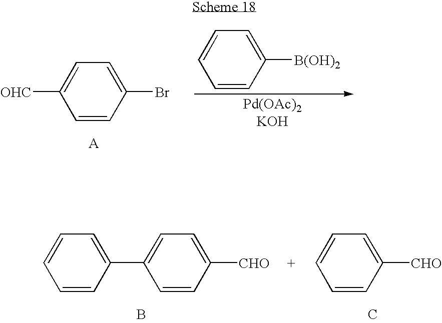

| | | Capillary | | | |
|---|---|---|---|---|---|
| Entry | Power | Diameter | flowrate | Solvent | Ratio A:B:C |
| *1 | 100 W | 380 μm | 15 μl/min. | DMF/ | 36(A):17(B):47(C). |
| | | | | H₂O | |
| 2 | 60° C. | RBF | Batch | THF | At 1.5 h; 29(A):71(B). |
| | | | Reaction | | At 4 h; 22(A):78(B). |

Scheme 18 conditions: Stream A; 1 equiv of arylhalide, 5 equiv of base, 5 mol % Pd(OAc)₂ in THF. Stream B; 1.2 equiv boronic acid.
Ratio A:B:C represents the ratio of the 2 products B and C relative to starting material A as determined by ¹H NMR. In entries were C is not specified, it was not observed.
*This reaction was performed with a capillary tube which was coated internally with palladium.
Entry 2, batch reaction refers to the identical reaction as entry 1, performed under similar conditions (i.e. same concentration) using “standard” chemical techniques (i.e. round bottomed flask with stirrer) performed at 60° C. with the aid of an oil bath

### Example 19

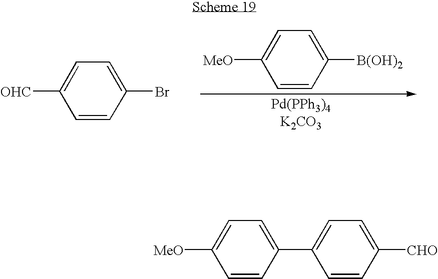

| | | Capillary | | | |
|---|---|---|---|---|---|
| Entry | Power | Diameter | Flowrate | Solvent | Conversion |
| 1 | 170 W | 380 μm | 25 μl/min | DMF/H₂O | 92% |

Scheme 19 conditions: Stream A; 1 equiv of arylhalide, 5 equiv of base, 5 mol % Pd catalyst in THF. Stream B; 1.2 equiv boronic acid.

### Example 20

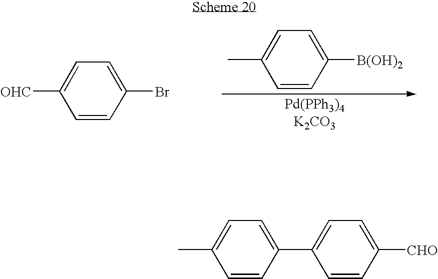

| | | Capillary | | | |
|---|---|---|---|---|---|
| Entry | Power | Diameter | Flowrate | Solvent | Conversion |
| 1 | 170 W | 380 μm | 25 μl/min | DMF/H₂O | 25% |
| 2 | 170 W | 380 μm | 25 μl/min | DMF/H₂O | 39% |

Scheme 20 conditions: Stream A; 1 equiv. of arylhalide, 5 equiv. of base, 5 mol % Pd catalyst in THF. Stream B; 1.2 equiv. boronic acid.

### Example 21

### Example 21a: Suzuki-Miyaura Coupling

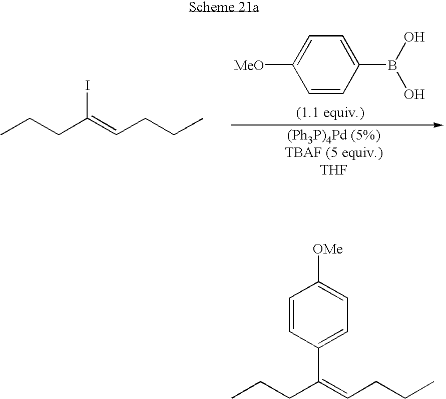

| | | | Capillary | Flowrate | |
|---|---|---|---|---|---|
| Entry | Time | Power | Diameter | (μL/min) | Conversion |
| 1 | 60 min | RT | RBF | Control | 0% |
| 2 | 15 min | 100 W | 200 μm | No flow | 100% |
| | | | | sealed | |
| | | | | tube | |
| 3 | 13.9 min | 100 W | 200 μm | 2 | 100% |

Scheme 21a shows a Suzuki-Miyaura coupling reaction. Entry 1 represents the reaction carried out under standard conditions in a RBF at RT. Entry 2 represents the same reaction carried out in a capillary under 100 W microwave irradiation in a sealed tube. Entry 3 represents the reaction carried out under similar conditions to entry 2 with premixed solutions flowed though one inlet. Both microwave reactions gave full conversion to the desired final product, while the standard method gave no conversion to the desired product.

### Example 21b: Ring-closing Metathesis

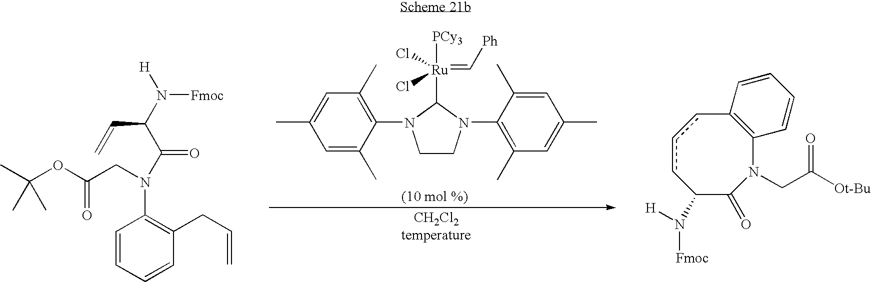

| | | | Capillary | Flowrate | |
|---|---|---|---|---|---|
| Entry | Time | Power | Diameter | (μL/min) | Conversion |
| 1 | 30 min | 35° C. | RBF | Control | 30% |
| 2 | 30 min | 200 W | Microwave | Control | 100% |
| | | | vial (std) | | |
| 3 | 1.9 min | 100 W | 380 μm | 40 | 100% |
| | | | capillary | | |

Scheme 21b shows a ring-closing metathesis reaction. As in Example 21a, Entry 1 represents the experiment under standard conditions, Entry 2 under microwave conditions with no flow (in this case in a microwave vial), and 3 under microwave conditions with flow though one inlet. Again conversion to the final product was 100% under both microwave conditions while the standard reaction conditions yielded only 30% conversion to product.

### Example 21c: Wittig Olefination

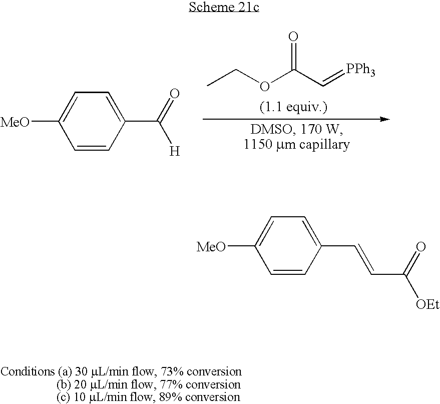

| | | Capillary | Flowrate | |
|---|---|---|---|---|
| Entry | Power | Diameter | (μL/min) | Conversion |
| 1 | 170 W | 1150 μm | 30 | 73% |
| | | capillary | | |
| 2 | 170 W | 1150 μm | 20 | 77% |
| | | capillary | | |
| 3 | 170 W | 1150 μm | 10 | 89% |
| | | capillary | | |
| 4* | 280 W | | No flow | 54% |
| | | | sealed | |
| | | | tube | |

Scheme 21c shows a Wittig olefination reaction. This experiment demonstrates the effect of flow rate on the reaction kinetics. In this case a slower flow rate resulted in greater yield of products however even the faster flow rate gave improved yield over no flow. * Entry 4 is based on results reported in available literature. The reaction was fully heterogeneous. Such conditions would likely pose a serious problem for prior art microchannel reactor technology as it would lead to clogged channels and/or frits.

### Example 22: Examining Reaction Parameters

### Example 22a: Power Setting

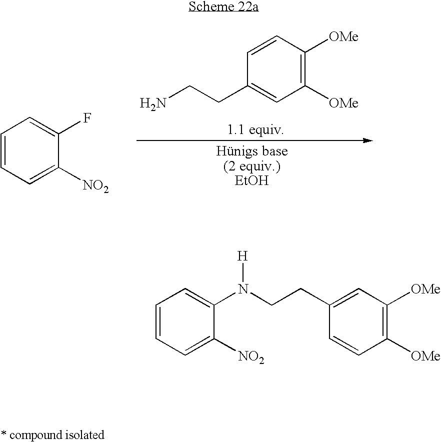

Power Setting

| | | Capillary | | Molarity | |
|---|---|---|---|---|---|
| Entry | Power | Diameter | Flowrate | (M) | Conversion |
| 1 | 200 W | 380 μm | 30 μL min | 0.43 | 61% |
| 2 | 100 W | 380 μm | 30 μL min | 0.43 | 58% |
| 3 | 50 W | 380 μm | 30 μL min | 0.43 | 41% |

Scheme 22a shows a nucleophilic aromatic substitution reaction. This Example demonstrates the effect of varying the power setting on such reactions. The reaction conditions were not optimized as they were designed to show relative differences. While the higher power setting often resulted in better yields, this was not always the case. Higher temperatures can result in decomposition of the catalysts, lowering yield.

### Example 22b: Capillary Diameter

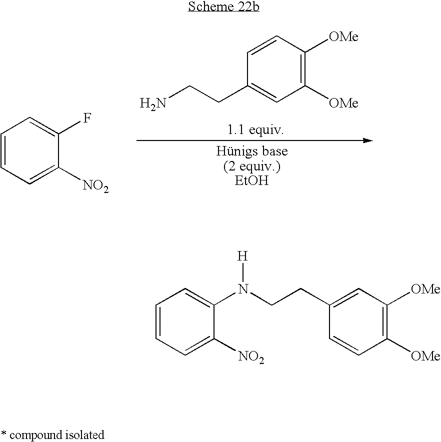

Capillary Diameter

| | | Capillary | | | Molarity | |
|---|---|---|---|---|---|---|
| Entry | Power | Diameter | | Flowrate | (M) | Conversion |
| 1 | 150 W | 200 | μm | 30 μL min | 0.43 | 47% |
| 2 | 150 W | 326 | μm | 30 μL min | 0.43 | 55% |
| 3 | 150 W | 380 | μm | 30 μL min | 0.43 | 60% |
| 4 | 150 W | 1100-1200 | μm | 30 μL min | 0.43 | 57% |

Scheme 22b shows a nucleophilic aromatic substitution reaction. This Example demonstrates the effect of varying the capillary diameter on such a reaction. The reaction conditions were not optimized as they were designed to show relative differences. It is apparent that a larger capillary diameter yields improved conversion but that a certain size, further increasing the capillary diameter, can produce a lower yield.

### Example 22c: Flowrate

| | | Capillary | | Molarity | |
|---|---|---|---|---|---|
| Entry | Power | Diameter | Flowrate | (M) | Conversion |
| 1 | 150 W | 380 μm | 15 μL min | 0.43 | 76% |
| 2 | 150 W | 380 μm | 45 μL min | 0.43 | 57% |
| 3 | 150 W | 380 μm | 60 μL min | 0.43 | 54% |

The reaction presented in Scheme 22b was repeated with varying flowrates. The reaction conditions were not optimized as they were designed to show relative differences. This experiment demonstrates that the slower the flow rate, the better the yield.

### Example 22d: Reaction Concentration

The reaction presented in Scheme 22b was repeated with varying reactant concentrations.

| | | Capillary | | Molarity | |
|---|---|---|---|---|---|
| Entry | Power | Diameter | Flowrate | (M) | Conversion |
| 1 | 150 W | 380 μm | 30 μL min | 0.23 | 52% |
| 2 | 150 W | 380 μm | 30 μL min | 0.43 | 60% |
| 3 | 150 W | 380 μm | 30 μL min | 0.74 | 66% |

The reaction conditions were not optimized as they are designed to show relative differences. Generally it was found that reactions followed standard rules of kinetics, i.e., the higher the concentration, the faster the rate.

### Example 22e: Effects of Coating Capillary with Thin Metal Film

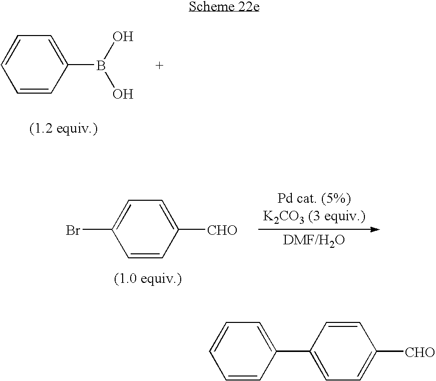

| | | | Capillay | |
|---|---|---|---|---|
| | | Flowrate | diameter | Percent |
| Conditions | Power (W) | (mL/min) | (μm) | Conversion |
| Pd(OAc)₂ | 170 | 30 | 1150 | 38% |
| K₂CO₃ | | | | (62% recovered) |
| DMF/H₂O | | | | |
| Pd(OAc)₂ | 170 | 30 | 1150 | 100% |
| KOH | | | | Pd Precipitated |
| DMF/H₂O | | | | to coat capillaries |

Scheme 22e shows a Suzuki-Miyaura coupling reaction performed in capillaries that were not coated with metal. Pd metal blacked out during the reactions with KOH. In the KOH run, the palladium catalyst provided in the solution started to precipitate as a coating or film during the reaction.

### Example 22f: Effects of Coating Capillary with Thin Metal Film: No Pd Catalyst Added

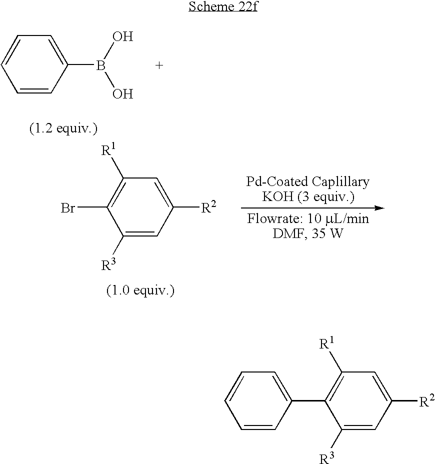

| | | Con- |
|---|---|---|
| | | ver- |
| Substituents | Product | sion |
| R¹ = R³ = H, R² = CHO | 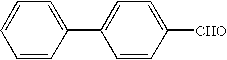 | 89% |
| R¹ = R³ = H, R² = CH₃ | 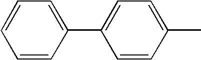 | 95% |
| R¹ = R³ = H, R² = OCH₃ | 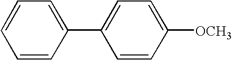 | 97% |
| R¹ = R³ = R² = CH₃ | 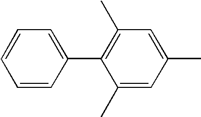 | 92% |

Scheme 22f shows a Suzuki-Miyaura coupling reaction with reactants having different substituents and with metal coated capillaries (i.e. capillaries 112 with lining 125). It was found that the metal lining dramatically increased reaction temperature and also percent conversion. The metal thin film itself can catalyse coupling reactions and no additional metal catalyst need be added. Using the metal-coated capillaries, much lower power settings were sufficient to produce very high temperatures at the reaction site.

### Example 22g: Effects on Reactions with Very High Reaction Barriers

Diels Alder Cycloaddition

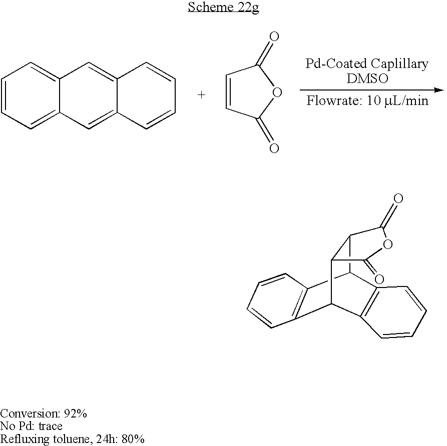

Scheme 22g shows a Diels Alder cycloaddition reaction performed in a Pd-coated capillary. This experiment demonstrates that metal-coated capillaries can be used with microwave irradiation to achieve good conversions for reactions with a very high reaction barrier. It was found that irradiations of the metal-coated capillary alone, with no solvent can produce steady temperatures of up to 300° C.

### Example 23: Experiments to Improve Reaction Throughput

### Example 23a: Two Inlets from Two Syringes

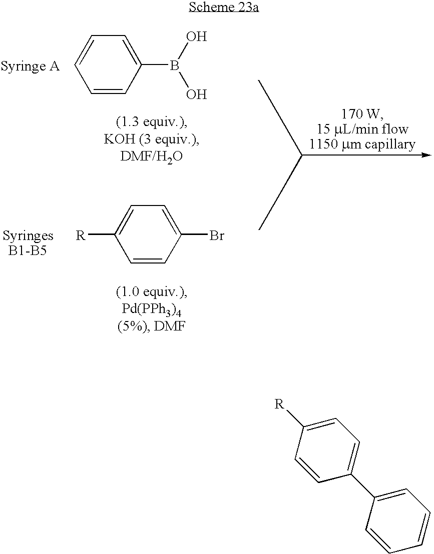

| | Product | Yield |
|---|---|---|
| Bromide (B1-3) | | |
| 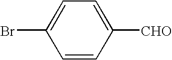 | 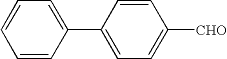 | 97% |
| 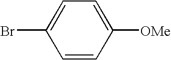 | 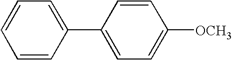 | 96% |
| 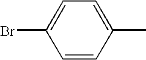 | 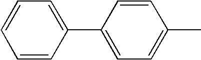 | 90% |
| Bromide (B4-5) | | |
| 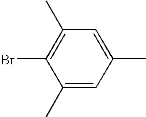 | 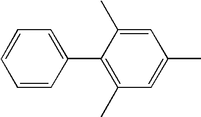 | 72% |
| 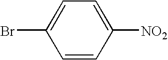 | 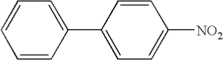 | 100% |

Scheme 23a shows a Suzuki-Miyaura coupling reaction performed using two inlets from two syringes to introduce reagents into the reaction mixture. This process may be referred to as “mixing on the fly”. The experiment demonstrates that the reaction can be carried out on substrates with a variety of substituents. The percent conversion varied depending on the substrates used in the reaction.

### Example 23b: Parallel Capillary Irradiation, Using a Multi-inlet Reactor

This example was performed using an apparatus similar to that of FIGS. 4 and 6. “Syringe A1” referred to below generally equates to a supply of reagent 230a; “Syringe A2” to reagent 230b; “Syringe B1” to reagent 230c; and “Syringe B2” to reagent 230d.

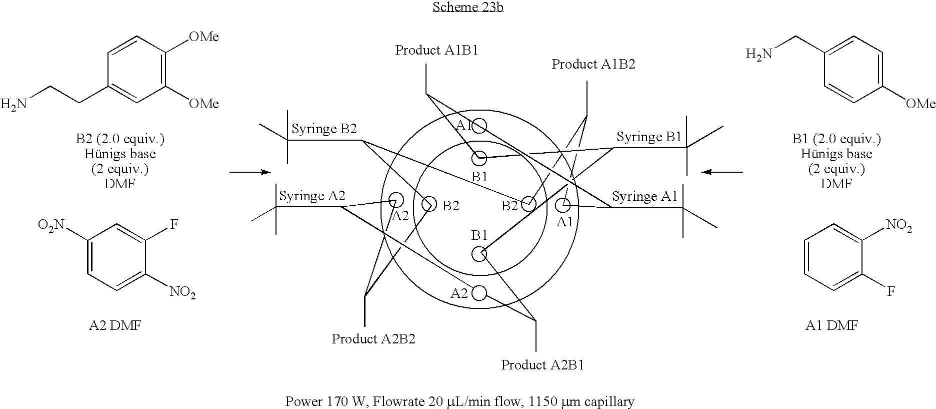

| | 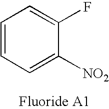 | 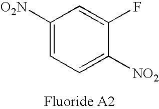 |
|---|---|---|
| 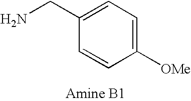 | 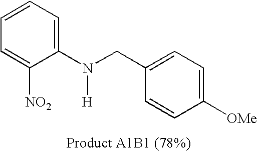 | 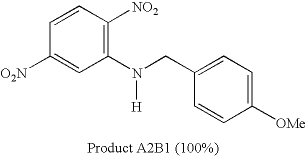 |
| 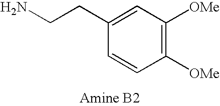 | 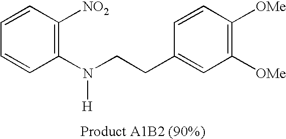 | 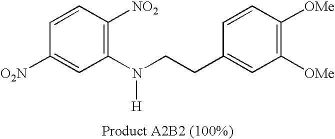 |

Scheme 23b shows a nucleophilic aromatic substitution performed in parallel, using multi-inlet reactor similar to reactor 210 of FIG. 4. This method was used to prepare libraries of compounds by continuous flow, simultaneous, parallel, capillary irradiation, using a multi-inlet reactor. This example shows the preparation of a collection or library of secondary amines prepared by nucleophilic aromatic substitution. The library was prepared by continuous flow, simultaneous, parallel capillary irradiation using a multi-inlet reactor. The following conditions were used for all of the experiments: 1 equiv. of reagents A in DMF, 2 equiv. of B in DMF 170 W, 1150 mm capillary, 20 mL/min. The simultaneous parallel capillary experiment yielded good conversions, no interference was observed due to the presence of several capillaries in the chamber at once.

### Example 23c: Simultaneous Sequential Parallel Capillary Irradiation

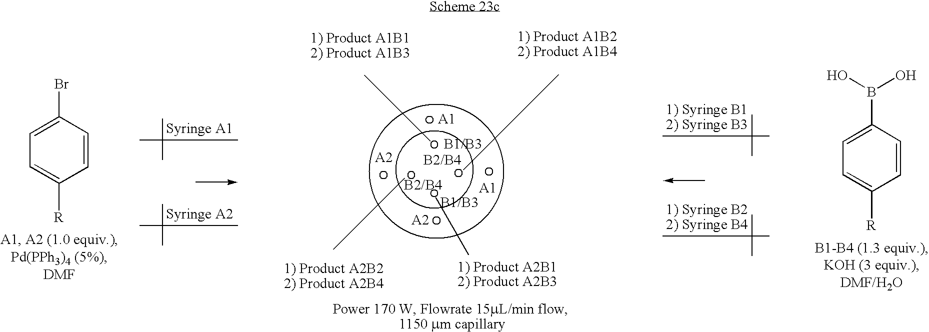

| Boronic Acid | 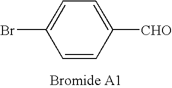 | 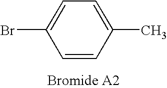 |
|---|---|---|
| 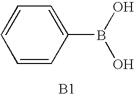 | 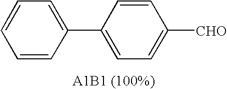 | 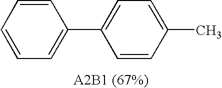 |
| 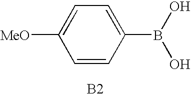 | 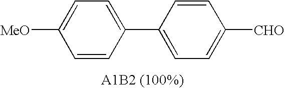 | 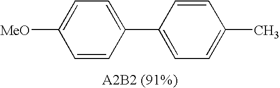 |

Run 1: 6 minutes, Switch valve to rinse, Switch valve to new Boronic acid

| | | |
|---|---|---|
| 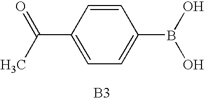 | 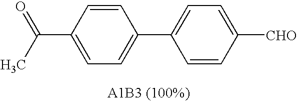 | 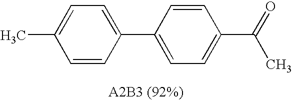 |
| 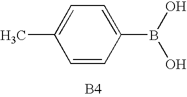 | 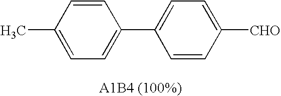 | 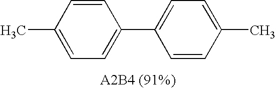 |

Scheme 23c shows the preparation of libraries of compounds by a cross coupling reaction using continuous flow, simultaneous, sequential, parallel capillary irradiation using a multi-inlet reactor system. The substrates can be switched and infused through the parallel reactor to prepare compounds that are separated in time as shown in the scheme above. The reactions conditions were as follows: (Ph₃P)₄Pd (5%), K₂CO₃ (5 equiv.), DMF/H₂O

### Example 23d: Multi-Component Reactions Using Continuous Flow, Sequential, Capillary Irradiation in a Multi-inlet Reactor

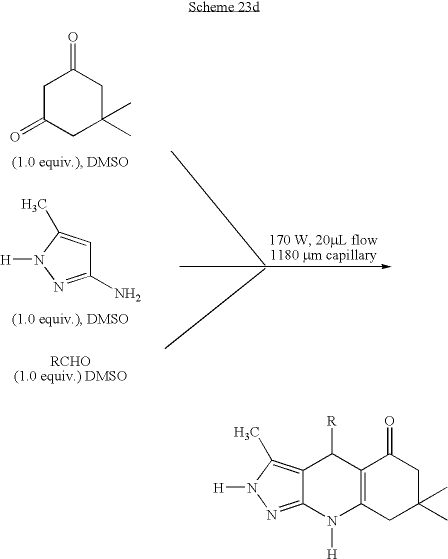

Scheme 23d shows a 3-component reaction and this experiment demonstrates the use of the multi-inlet reactor in the preparation of compounds from multi-component reactions.

### Example 23e: Multi-Component Reactions Using Continuous Flow, Sequential, Capillary Irradiation in a Multi-inlet Reactor

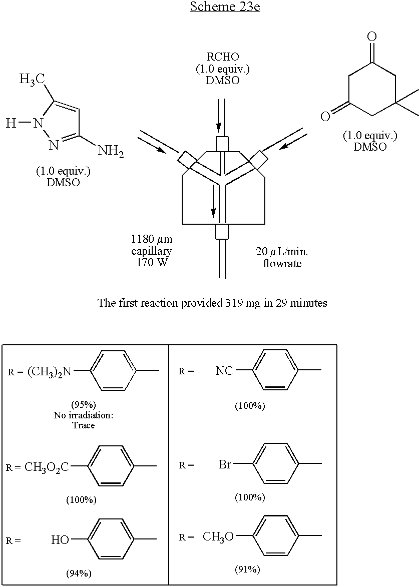

Scheme 23e shows a reaction involving a 3-component library This example demonstrates the use of the multi-inlet reactor for the preparation of libraries of compounds made by continuous flow, sequential, parallel, 3-component reactions.

### Example 23f: Additional Multi-Component Reaction Using Continuous Flow, Sequential, Capillary Irradiation in a Multi-inlet Reactor

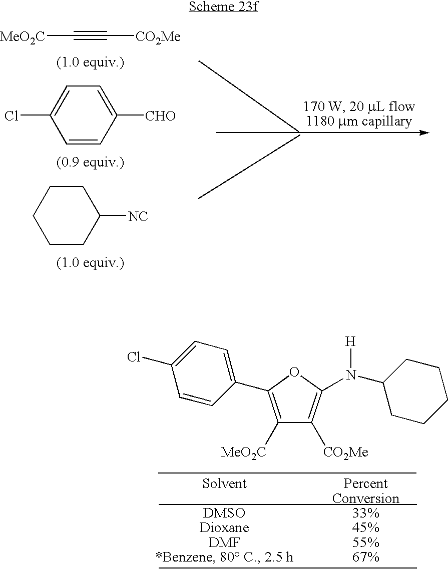

*The percent conversion in Benzene was determined from the literature.

Scheme 23f shows a 3-component cyclization reaction to provide furans made by continuous flow, sequential, parallel, 3-component reactions.

### Example 23g: Additional Multi-Component Reaction Using Continuous Flow, Sequential, Capillary Irradiation in a Multi-inlet Reactor

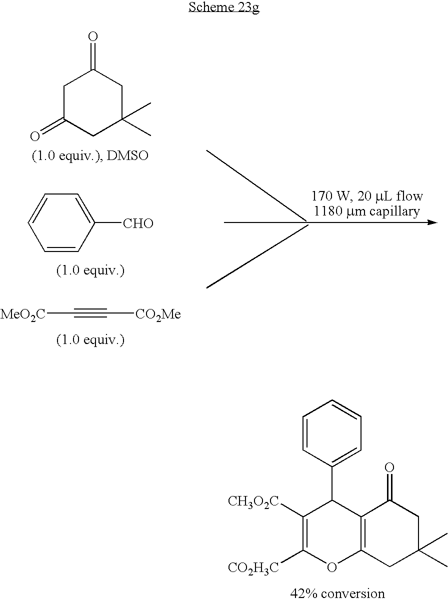

Scheme 23g shows a 3-component cyclization reaction to provide fused pyrans furans made by continuous flow, sequential, parallel, 3-component reactions

### Example 23h: Multi-Component, Multi-Step, Reactions Using Continuous Flow, Sequential, Capillary Irradiation in a Multi-inlet Reactor

Not all functional groups are compatible for ‘all-in-one’ multi-component reactions. The parallel reactor was adapted for ‘queued’ reactions where reaction intermediates, rather than starting materials, can be flowed through it or back through it. This reactor is shown schematically in FIG. 8.

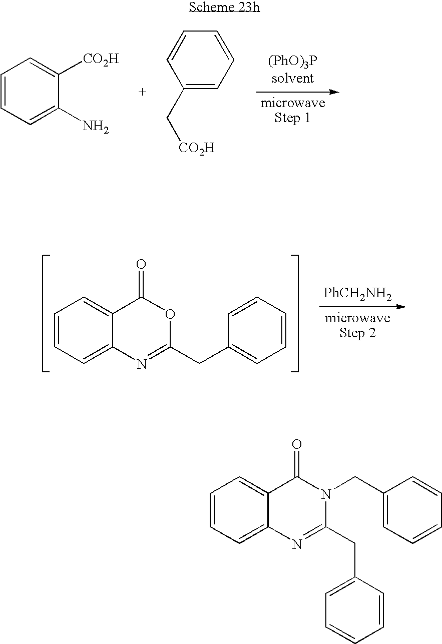

| Step | Capillary | Solvent | Flowrate | Conversion |
|---|---|---|---|---|
| 1 | 1180 μm | pyridine | 30 | 0% |
| 1 | 1180 μm | pyridine | 60 | 3% |
| 1 | 1180 μm-Pd | pyridine | 30 | 82% |
| 1 | 1180 μm | DMF | 30 | 0% |
| 1 | 1180 μm-Pd | DMF | 60 | 0% |
| 2 | 1180 μm-Pd | pyridine | 30 | complete |

Scheme 23h shows a 3-component reaction to provide quinazolinones. This scheme shows multi-component, multi-step experiments conducted under various conditions. While optimization of the conditions may be required it is clear that complex reactions of this type can be carried out using microwave irradiation in a multi-inlet reactor.

Continuous Flow Library

TABLE 1

| Compound 1 | 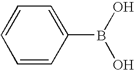 | Product | Conditions | Conversion |
|---|---|---|---|---|
| Compound 2-1 | 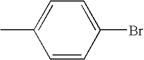 | 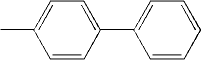 | 25 μl min 100 W 380 μM capillary | *100% |
| Compound 2-2 | 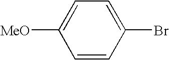 | 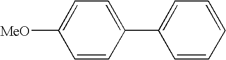 | 25 μl min 100 W 380 μM capillary | *96% |
| Compound 2-3 | 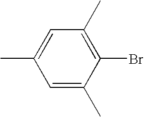 | 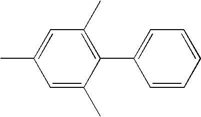 | 25 μl min 100 W 380 μM capillary | *19% |
| Compound 2-4 | 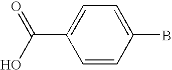 | 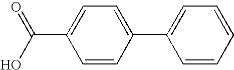 | 25 μl min 100 W 380 μM capillary | *100% |
| Compound 2-5 | 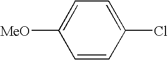 | 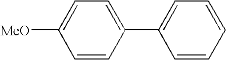 | 25 μl min 100 W 380 μM capillary | Trace Quantities (1%) |

*compound isolated
Table 1 conditions: 1 mmol of arylhalide, 1 mmol of boronic acid, 3 mmol of Na₂CO₃, 5 mol % Pd(OAc)₂, 1 mmol of tetrabutylammonium bromide, 2 ml of water.
The above details a library produced continuously. This library can be performed using 1 inlet stream in which the reagents are premixed and flowed through the system or via 2 inlet streams in which compound 1 is flowed continuously through inlet 1 while compounds 2 are introduced via inlet 2.

TABLE 2

| Stream A | 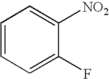 | Product | Conditions | Conversion |
|---|---|---|---|---|
| Stream B Compound 1 | 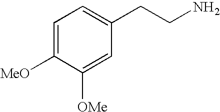 | 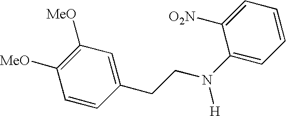 | 30 μl min 180 W 380 μM capillary | 87% |
| Stream B Compound 2 | 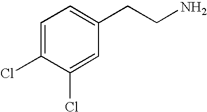 | 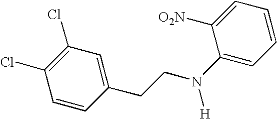 | 30 μl min 180 W 380 μM capillary | *57% |
| Stream B Compound 3 | 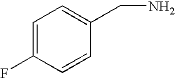 | 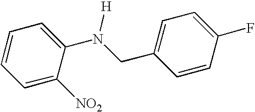 | 30 μl min 180 W 380 μM capillary | *64% |
| Stream B Compound 4 | 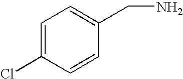 | 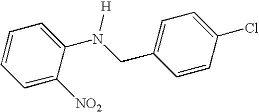 | 30 μl min 180 W 380 μM capillary | *47% |
| Stream B Compound 5 | 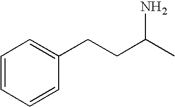 | 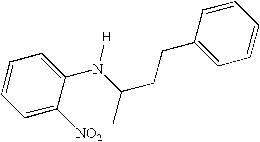 | 30 μl min 180 W 380 μM capillary | *40% |

Table 2 conditions: Stream A 1 mmol of fluoronitrobenzene and 2 mmol of diisopropylethylamine in DMF. Stream B 1 mmol of amino compounds 1-5 in DMF
*compound isolated
The above details a library produced continuously. This library can be performed using 1 inlet stream in which the reagents are premixed and flowed through the system or via 2 inlet streams in which stream A contains the fluoronitrobenzene and base while stream B contains the substrate amine.

TABLE 3
Parallel Synthesis
2 × 2 Combinatorial Reactions

| | Aryl Fluoride | |
|---|---|---|
| Reactive Amines | 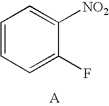 | 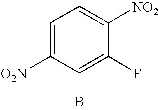 |
| 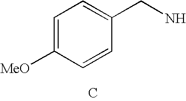 | 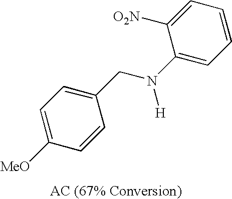 | 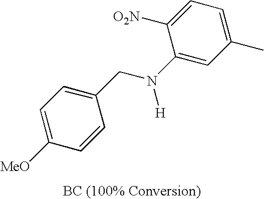 |
| 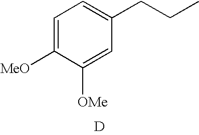 | 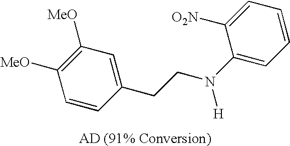 | 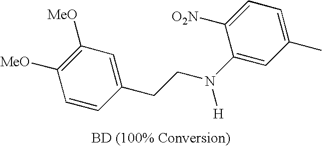 |

Conditions: The apparatus used is similar to that shown in FIG. 4.
Syringe A; 1 mmol of 1-fluoro-2-nitrobenzene in 1 ml of DMF.
Syringe B; 1 mmol of 1-fluoro-2,4-dinitrobenzene in 1 ml of DMF.
Syringe C; 2 mmol of 4-methoxybenzylamine and 2 mmol of Diisopropylethylamine in 1 ml of DMF.
Syringe D; 2 mmol of 2-(3,4-Dimethoxy-phenyl)-ethylamine and 2 mmol of Diisopropylethylamine in 1 ml of DMF.
With reference also to FIG. 6,
Inlets A and C merge to a single channel to produce outlet AC. (240a)
Inlets A and D merge to a single channel to produce outlet AD. (240c)
Inlets B and C merge to a single channel to produce outlet BC. (240d)
Inlets B and D merge to a single channel to produce outlet BD. (240b)
Syringes A, B, C and D were set up as shown in FIG. 3. The solutions were passed through the system at 20 μl/min using a syringe pump. Microwave heating was performed at power level of 170 W.

TABLE 4
Suzuki-Miyara coupling of aryl boronic acids and bromides using
MACOS through Pd-coated capillaries. (MACOS = Microwave Assisted
Continuous Organic Synthesis)

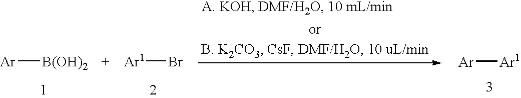

| | | | | T^{b} | | Convert^{d} |
|---|---|---|---|---|---|---|
| Entry | Ar′ (1) | Ar″ (2) | Cond.^{a} | (° C.) | Product (2) | yield |
| 1 | 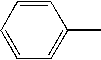 | 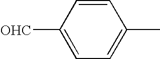 | A | 205 | 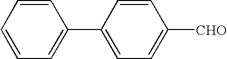 | 88% |
| 2 | 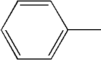 | 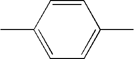 | A | 200 | 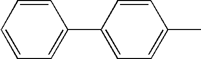 | 95% |
| 3 | 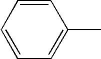 | 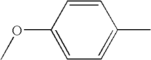 | A | 205 | 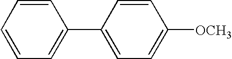 | 96.5% |
| 4 | 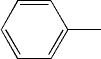 | 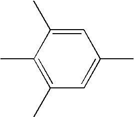 | A | 200 | 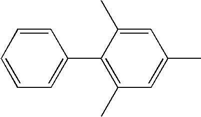 | 92% |
| 5 | 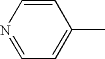 | 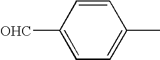 | B | 215 | 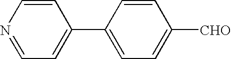 | 93% |
| 6^{f} | 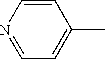 | 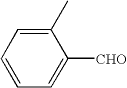 | B | 220 | 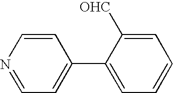 | 59% |
| 7^{f} | 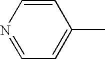 | 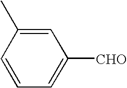 | B | 210 | 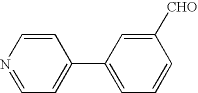 | 73% |
| 8 | 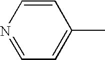 | 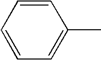 | B | 215 | 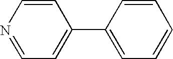 | 81% (74%)^{e} |
| 9^{f} | 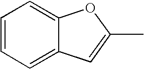 | 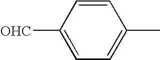 | B | 225 | 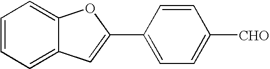 | 76% (84%)^{e} |

^{a}Reaction solutions were flowed through the Pd-coated capillary via a single inlet while being irradiated (see FIG. 1).
^{b}Refers to the temperature on the outer surface of the Pd-coated capillary as measured by the IR sensor of the Smith Creator microwave.
^{c}All reactions were performed using a 1150 micron (ID) Pd coated capillary.
^{d}Percent conversion was determined by withdrawing a crude sample directly from the effluent from the capillary and analyzing it by ¹H NMR spectroscopy.
The ratio of starting material to product determined the percent conversion (there were no visible byproducts present, only starting material and product were present in all cases).
^{e}Isolated yield was determined by capturing a known volume of effluent from the capillary and purifying the product by silica gel chromatography. From the volume, the actual amount (mmol) of starting material could be calculated.
^{f}In this case, 2.0 equivalents aryl boronic acid were used.

TABLE 5
Heck coupling of aryl iodides with acrolein derivatives using MACOS
through Pd coated capillaries.

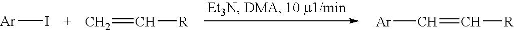

| | | | T^{b} | | Conversion |
|---|---|---|---|---|---|
| Entry | Ar^{a} | R | (° C.) | Product | Yield |
| 1 | 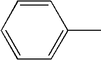 | —CO₂CH₃ | 205 | 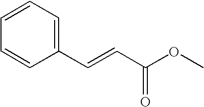 | 80% |
| 2 | 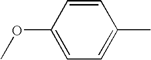 | —CO₂CH₃ | 200 | 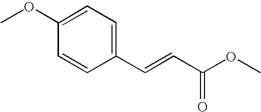 | 58% |
| 3 | 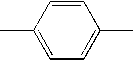 | —CO₂CH₃ | 205 | 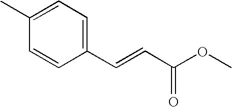 | 88.5% |
| 4 | 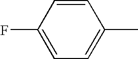 | —CO₂CH₃ | 200 | 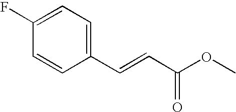 | 88.5% (79%)^{d} |
| 5 | 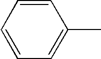 | —CO₂C(CH₃)₃ | 215 | 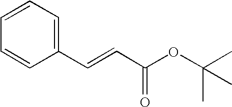 | 99% |
| 6 | 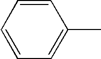 | CN | 220 | 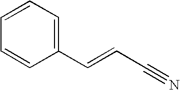 | 99% (82%)^{d} |

^{a}Reaction solutions containing aryl iodide (1.0 equiv.), acrylate (1.3 equiv.) and base (3.0 equiv.) in solvent were premixed and flown through the Pd coated microcapillary via a single inlet while being irradiated at the specified flowrate
^{b}Refers to the temperature on the outer surface of the Pd coated microcapillary as measured by the IR sensor.
^{c}Percent conversion was determined by ′H NMR spectroscopy relative to the residual starting material.
^{d}Isolated yield was determined from the product isolated from the small volume of sample collected using the above procedure.

1. A reactor apparatus comprising:
a) at least one reaction capillary having a lumen for receiving a reactant to undergo a reaction, and
b) a microwave source adjacent the capillary for irradiating reactant contained in at least a portion of the capillary with microwaves.

2. The apparatus of claim 1, wherein the capillary has an inner surface that is provided with a lining adapted to facilitate the reaction of the reactant.

3. The apparatus of claim 2, wherein the lining is of a microwave-absorbing material.

4. The apparatus of claim 3, wherein the lining is of a material that provides a chemical catalyst for the reaction.

5. (canceled)

6. The apparatus of claim 1, further comprising a reactant supply in fluid communication with the lumen of the capillary.

7. The apparatus of claim 6, further comprising a manifold coupled downstream of the reactant supply and upstream of the capillary.

8. The apparatus of claim 7, wherein the manifold has at least one outlet port and a plurality of inlet ports in fluid communication with said at least one outlet port.

9. The apparatus of claim 8, wherein the reactant supply comprises a plurality of reagent reservoirs in fluid communication with respective ones of the plurality of inlet ports of the manifold.

10. The apparatus of claim 9, further comprising a flow inducer for urging the reagent from each reservoir to the respective inlet ports.

11. The apparatus of claim 1, further comprising a collection vessel at a downstream end of the reaction capillary for receiving product from the capillary.

12. The apparatus of claim 1, further comprising an analyzer in fluid communication with the downstream end of the capillary for in-process confirmation of satisfactory reaction of the reactant within the capillary.

13. The apparatus of claim 1, wherein the reaction capillary has a straight cylindrical shape along an axial length extending between upstream and downstream ends.

14. The apparatus of claim 1, wherein the reaction capillary has an inner diameter that is less than about 1500 microns.

15. A capillary tube device for providing a reaction chamber, the device comprising:
a) a generally cylindrical wall having an inner surface defining a lumen;
b) a reaction-enhancing film lining the inner surface, the film configured to contact a reactant contained in the device.

16-20. (canceled)

21. A method of micro-reacting a reactant comprising:
a) providing a capillary;
b) passing a reactant through the capillary; and
c) irradiating the reactant in the capillary with microwaves to facilitate a chemical reaction in the capillary by which the reactant is converted into a product.

22. The method of claim 21, wherein the capillary includes a reaction-enhancing film on an inner surface thereof for contacting the reactant passing through the capillary.

23. The method of claim 22, wherein the microwave energy is absorbed by the film and transferred to the reactant as heat.

24. The method of claim 22, wherein the film provides a chemical catalyst for the reaction.

25. The method of claim 22, wherein the film comprises palladium.

26. The method of claim 22, wherein the film has a thickness of about 6 microns.

27-32. (canceled)
